(19) United States
(12) Patent Application Publication
(10) Pub. No.: US 2003/0188278 A1
(43) Pub. Date: Oct. 2, 2003

(54) Method and apparatus for accelerating digital logic simulations

(76) Inventor: Susan Elizabeth Carrie, (US)

Correspondence Address: SUSAN E. CARRIE, 1132 KAREN WAY, MOUNTAIN VIEW, CA, 94040, US

(21) Appl. No.: 10/396,996

(22) Filed: Mar. 25, 2003

Related U.S. Application Data
(60) Provisional application No. 60/367,838, filed on Mar. 26, 2002.

(51) Int. Cl. G06F 17/50

(52) U.S. Cl. 716/4

(57) ABSTRACT

A logic simulation system comprised of a simulation network, terminal nodes, routing nodes, and system control and user interface. Simulation network supports any topology and may be reconfigured after mapping the logic to be simulated onto the system. Communications between terminal nodes and routing nodes, are performed using packets. Simulation processing is coordinated using semaphores. Special purpose terminal nodes and routing nodes optimize the generation and use of semaphores. System control and user interface uses semaphores to control the progress of a simulation.

### CROSS REFERENCE TO RELATED APPLICATIONS

This application claims the benefit of U.S. Provisional Application No(s). 60/367,838, filed Mar. 26, 2002.

### BACKGROUND OF THE INVENTION

Logic simulators enable a logic circuit to be modeled and circuit behavior to be predicted without the construction of the actual circuit. Logic simulators are used to identify functionally incorrect behavior before fabrication of the logic circuit. Use of logic simulators requires the translation of a netlist or other logic circuit description into a form which is understood by the simulator (a process referred to as mapping a netlist).

Logic simulation accelerators are devices which increase the speed at which a logic simulation takes place. Prior art logic simulation accelerators have involved arrays of similar processing units which are highly interconnected with special purpose communications links. Further, the communications between separate processing elements within logic simulation accelerators has required that the sender of information transfer such information when the receiver expects it. The nature of the interconnect and communication has limited the size of logic circuit which can be simulated. Further, the form of interconnect and communication has limited the types of processors which can be used within the logic simulation accelerator, It has also limited the ability to add new types of processing elements to a existing logic simulation accelerator. Further, prior art has provided a limited amount of memory for simulating ram arrays within the logic circuit and limited connectivity to that memory. The restrictions placed on the size and configuration of logic circuits has led to the requirement for large amounts of input from the user of the system regarding how to map the logic circuit.

Prior art has also limited the number of clock domains, latch based circuits and asynchronous circuits which can be supported.

Prior art has also limited the number of interfaces to co-simulators, I/O interface cards, and general purpose computers which are used to control the simulation and provide an interface with the user. This has resulted in bottlenecks which reduce the performance of the simulation system.

### SUMMARY OF THE INVENTION

It is an object of the present invention to provide a logic circuit simulation system which permits simulation of extremely large logic circuits with arbitrary circuit configurations. The invention further allows an arbitrary splitting of a logic circuit between the logic circuit simulation system and other simulation devices, including a plurality of host computers, co-simulators, and I/O interface cards. Further, the invention allows the use of dissimilar processors to accelerate the simulation of the logic circuit.

The logic circuit simulation system contains an accelerator, and simulation control and user interface. The simulation control and user interface is comprised of a control network and control nodes. The accelerator is comprised of a configurable simulation network which supports optimal configuration of the network topology for a particular logic circuit. The accelerator contains a plurality of routing nodes and a simulation network which is expandable and configurable and is used by the routing nodes to communicate with each other. The accelerator further contains a plurality of terminal nodes which perform logic simulation processing on a portion of a logic circuit using data transferred over the simulation network. The invention includes specific embodiments of the terminal node which are optimized for logic simulations, memory block simulations, co-simulations, I/O interfaces, and network interfaces. The terminal nodes contain a semaphore means which is used to efficiently synchronize and serialize use and generation of simulation data. The accelerator interfaces to a simulation control and user interface block which controls the progress of the simulation and can interface the accelerator to a plurality of co-simulations and to the user.

The invention further includes a mapper for compiling or mapping a logic circuit which detects deadlock when the circuit is mapped.

Further, the mapping means provides instructions to the logic circuit simulation system so that deadlock does not occur and logic loops are properly simulated by the logic circuit simulation system. Further, the mapping means provides instructions to the logic circuit simulation system so that arbitrary circuit configurations which may include arbitrary clocking configurations may be properly simulated by the logic circuit simulation system.

### BRIEF DESCRIPTION OF THE DRAWINGS

Reference is made to the accompanying drawings in which are shown illustrative embodiments of aspects of the invention, from which novel features and advantages will be apparent.

FIG. 1 illustrates an entire simulation system..

FIG. 2 depicts major components of a logic circuit simulation system, including terminal nodes, which perform simulations, routing nodes, which route simulation network packet during simulation, and the simulation network.

FIG. 3A illustrates the transfer of a simulation network packet from a driver routing node to a sink routing node over a single communications link in the simulation network.

FIG. 3B illustrates the transfer of a simulation network packet from a source routing node, over a routing path comprised of multiple routing nodes and communications links, to a destination routing node.

FIG. 4 illustrates multiple example topologies of routing nodes and communications links.

FIG. 5 illustrates the partitioning of a simulation network packet into and address layer and a data layer.

FIG. 6 is a block diagram of a routing node chip which contains multiple terminal nodes, routing nodes and communications links.

FIG. 7 is a block diagram of rn_chassis which contains a base_rn_bd comprised of multiple routing node chip and multiple rn_bd connectors.

FIG. 8 is a block diagram of an rn_bd which contains multiple routing node chips and which may be inserted into an rn_chassis.

FIG. 9 illustrates an example arrangement of multiple rn_chassis which each contain a base_rn_bd and a plurality of rn_bds.

FIG. 10 illustrates the format of the address layer of multiple types of network communications layers, with each address layer being followed by a data layer.

FIG. 11 is a block diagram of a set of routing nodes arranged to form a sheet.

FIG. 12 illustrates the partitioning of a logic circuit onto an accelerator and the partitioning of the accelerator circuit subset onto multiple terminal nodes.

FIG. 13 illustrates the terminal node state, semaphores and expected semaphore values which are stored within terminal nodes.

FIG. 14 illustrates several categories of commands which may be transferred within the data layer of a simulation network packet.

FIG. 15 illustrates several categories into which signals are classified by a terminal node which uses or generates the values of these signals during a simulation.

FIG. 16 illustrates the transfer of signals between two terminal nodes during a simulation.

FIG. 17A illustrates a circuit in which a logic loops may exist.

FIG. 17B illustrates a circuit in which a logic loops may exist.

FIG. 18 illustrates a circuit subset which has been mapped onto a terminal node A, a circuit subset which has been mapped onto a terminal node B and the transfer of signals between terminal node A and terminal node B during a simulation.

FIG. 19 is a block diagram of a logic evaluation processor, which is an embodiment of a terminal node.

FIG. 20 is a block diagram of a memory storage processor, which is an embodiment of a terminal node.

FIG. 21 is a block diagram of an I/O interface processor, which is an embodiment of a terminal node.

FIG. 22 illustrates an I/O boundary specification which is used to define the interactions between an I/O interface processor and the remainder of the logic circuit simulation system.

FIG. 23 is a block diagram of a CRT display I/O interface processor, which is an embodiment of a terminal node.

FIG. 24 is a block diagram of a network I/O interface processor, which is an embodiment of a terminal node.

FIG. 25 is a block diagram of a user programmable terminal node.

FIG. 26 illustrates the algorithm used by an embodiment of simulation control and user interface to make use of the semaphores and expected semaphores which are stored within terminal nodes to control the execution of a simulation.

FIG.

### DETAILED DESCRIPTION OF THE INVENTION

### Contents

The detailed description includes the following sections:

System Overview

Routing Nodes and Simulation Network

Routing Nodes and Simulation Network: Tree Embodiment

Routing Nodes and Simulation Network: Sheet Embodiment

Terminal Nodes and Semaphores

Semaphore Usage

Logic Loop Elimination

Deadlock Prevention and Serialization of Evaluations

Semaphore Usage: Optimizations

Terminal Node: A Logic Evaluation Processor

Terminal Node: A Memory Storage Processor

Terminal Node: An I/O Interface Processor

Terminal Node: A Co-Simulation Control

Terminal Nodes: Summary

Simulation Control and User Interface: Preferred Embodiment

### System Overview

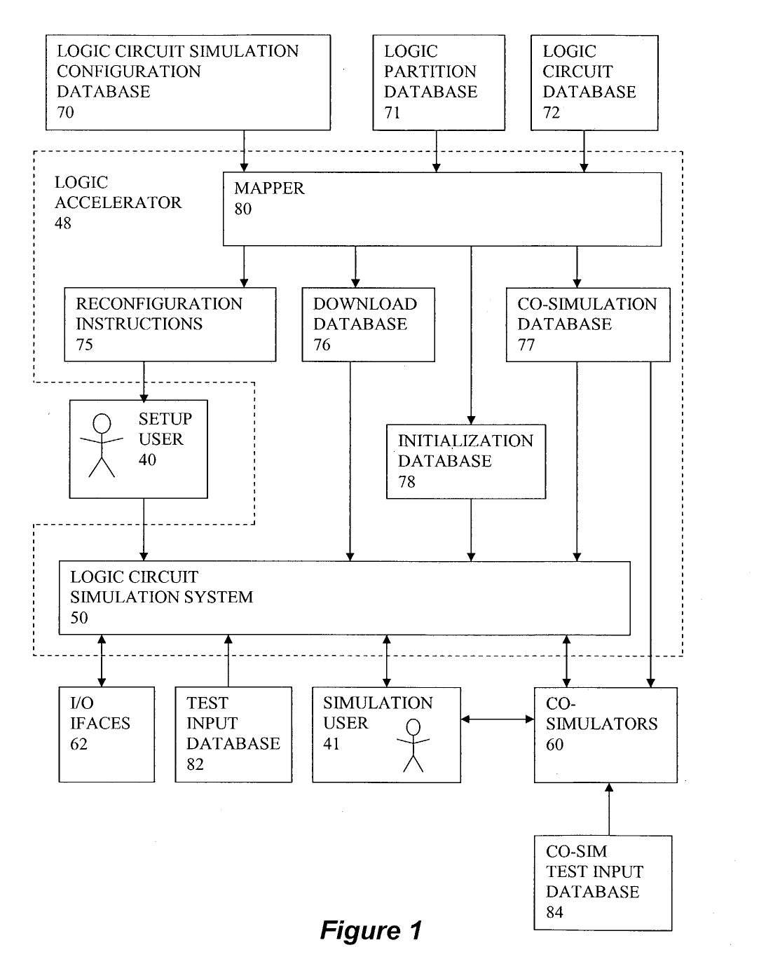

FIG. 1, depicts the invention, a logic accelerator 48, within a block diagram of the entire simulation system. A logic circuit database 72 describes the circuit to be simulated. A logic partition database 71 indicates which portions of the logic circuit should be mapped onto the logic circuit simulation system 50 and which portions of the logic circuit should be mapped onto the co-simulators 60. The logic partition database 71 also provides information regarding which portions of the logic circuit should be mapping onto which portions of the logic circuit simulation system 50. A logic circuit simulation system configuration database 70 describes the existing configuration of the logic circuit simulation system 50.

The mapper 80 is a software program which reads the logic circuit simulation system configuration database 70, logic partition database 71 and logic circuit database 72. The mapper 80 then processes this information to produce a download database 76 which contains a description of the circuit to be simulated in the format required by the logic circuit simulation system 50. The download database 76 also contains control information required by the logic circuit simulation system 50 to perform the simulations. The mapper 80 provides a co-simulation database 77 which describes the activities which should be performed by the co-simulators 60 during a simulation. The co-simulation database 77 also provides the information required by the logic circuit simulation system 50 to properly interface with the co-simulators 60 during a logic simulation. The mapper 80 provides reconfiguration instructions 75 to the user. The user reads these reconfiguration instructions 75 and makes adjustments to the configuration of the logic circuit simulation system 50. The processing of the logic circuit simulation configuration database 70, logic partition database 71 and logic circuit database 72 by the mapper 80 to produce reconfiguration instructions 75, download database 76, co-simulation database and initialization database 78, will be referred to as “compilation” or “compiling the logic circuit” or “mapping” or “mapping the logic circuit”. The time period during which this process takes place is referred to as “compile time”. The general concept of converting input databases into the databases required by a logic simulation accelerator 51 is known in the state of the art. Only those features of the mapper 80 which are specific to the current invention are described along with the details of the invention.

The logic circuit simulation system 50 is initialized when the simulation user 41 provides a simulation initialization directive to the logic circuit simulation system 50. The download database 76 and co-simulation database 77 are read by the logic circuit simulation system 50 and are used to initialize the logic circuit simulation system 50 and the co-simulators 60. Next, the initialization database 78 is read by the logic circuit simulation system 50 and is used to alter specific simulation signal values within the logic circuit simulation system 50.

A simulation is begun when the user provides a simulation start directive to the logic circuit simulation system 50. The simulation user 41 also starts the co-simulators 60 using the interface which is native the co-simulator. During a simulation the test input database 82, which contains stimulus, is read by the logic circuit simulation system 50. The co-simulators 60 read the co-sim test input database 84 which contains stimulus for the co-simulators 60. While the simulation progresses the logic circuit simulation system 50 interfaces with the co-simulators 60, the I/O interfaces 62 and the simulation user 41.

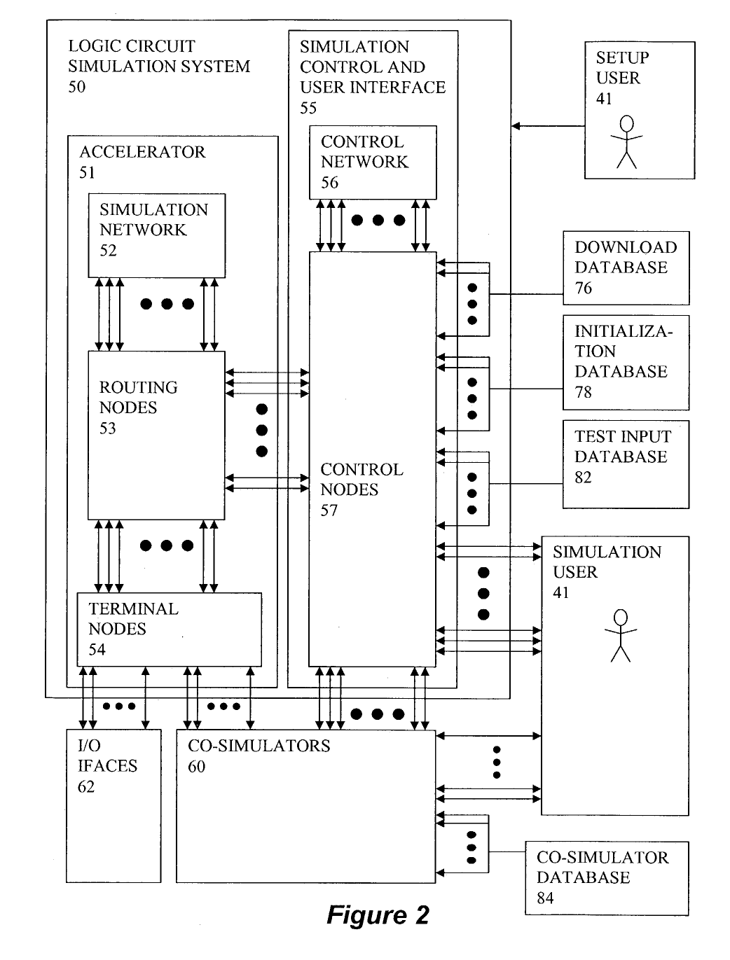

FIG. 2 depicts additional details of the logic circuit simulation system 50 and the interfaces to other simulation system components. The logic circuit simulation system 50 is comprised of an accelerator 51, and a simulation control and user interface 55. The accelerator 51 is further comprised of routing nodes 53, a simulation network 52, and terminal nodes 54. Each terminal node 54 may be attached to one or more routing nodes 53. Conversely, each routing node may be attached to one or more terminal nodes 54. Each routing node 53 is attached to the simulation network 52.

The simulation control and user interface 55 is comprised of one or more control nodes 57, and a control network 56. Each control node 57 has access to the download database 76, initialization database 78, co-simulation 32, and test input database 82. Each control node 57 interfaces to zero or more co-simulators 60. Each control node 57 interface may interface directly to the simulation user 41. Each control node 57 is attached to the control network 56. If there is only one control node 57 then there is no control network 56.

The accelerator 51, and the simulation control and user interface 55 communicate with each other via connections between the routing nodes 53 and the control nodes 57. Each routing node 53 may interface to zero or more control nodes 57. Each control node may interface to zero or more routing nodes 53. However, at least one routing node 53 is connected to at least one control node 57.

To initialize the logic circuit simulation system 50 the simulation user 41 supplies a simulation initialization directive to a subset of the control nodes 57. The control nodes 57 may use the control network 56 to communicate the simulation initialization directive to control nodes 57 which were not in the subset. Each control node then reads the download database 76, initialization database 78, and co-simulation database 77, reformats the simulation initialization directive, and sends the reformatted simulation initialization directive to a subset of the routing nodes 53 which are attached to that control node 57. The routing nodes 53 use the simulation network 52 to transfer the reformatted simulation initialization directive to other routing nodes 53. Each routing node 53 which receives the reformatted simulation initialization directive determines whether the terminal nodes 54 which are attached to the routing node 53 should receive the reformatted simulation initialization directive. If so, the reformatted simulation initialization directive is transferred to those terminal nodes 54.

To begin a simulation the simulation user 41 supplies a simulation start directive to a subset of the control nodes 57. The control nodes 57 may use the control network 56 to communicate this simulation start directive to control nodes 57 which were not in the subset. The control nodes 57 read the test input database 82. Each control node 57 determines which simulation start directive information is required by the routing nodes 53 attached to that control node 57. The simulation start directive is reformatted and the reformatted simulation start directive is sent to the attached routing nodes 53. The routing nodes 53 pass the reformatted simulation start directive through the simulation network 52 to additional routing nodes 53. Each routing node 53 which receives the reformatted simulation start directive determines whether the terminal nodes 54 which are attached to the routing node 53 should also receive the reformatted simulation start directive. If so, the reformatted simulation start directive is transferred to those terminal nodes 54. Upon receiving such information a terminal node 54 performs the processing specified and sends any expected response to a subset of the routing nodes 53 to which it is attached. This response is transferred, via the simulation network 52 and other routing nodes 53, to the appropriate control nodes 57. The control nodes 57 examine the responses and the test input database 82 to determine when to send additional information. This process continues until the test input database 82 is exhausted or until some user specified condition occurs.

During the simulation each control node 57 examines the test input database 82 and the responses from the terminal nodes 54 to determine if information should be sent to any co-simulators 60 attached to that control node 57. If input should be sent then the control node 57 uses the interface which is native to that co-simulator 60. Similarly, the co-simulator interface is used to gather information from that attached co-simulator 60. This information is used, along with the test input database 82 and the terminal node 54 responses to construct information to be sent to routing nodes 53.

It is possible for a terminal node 54 to interface directly with a co-simulator 60. In such a case the terminal node 54 will examine its internal databases to determine if information should be sent to any co-simulators 60 attached to that terminal node 54. If input should be sent then the terminal node 54 uses the interface which is native to that co-simulator 60. Similarly, the co-simulator interface is used to gather information from an attached co-simulator 60. This information is used, along with the internal databases to construct information to be sent to routing nodes 53.

It is also possible for a terminal node 54 to interface directly with an I/O interface 62. In such cases the terminal node 54 will examine its internal databases to determine which signals and values it should drive across the I/O interface 62. In addition, the terminal node 54 will gather the value of all of the signals of the I/O interface 62. This information is used, along with the internal databases to construct information to be sent to routing nodes 53.

### Routing Nodes and Simulation Network

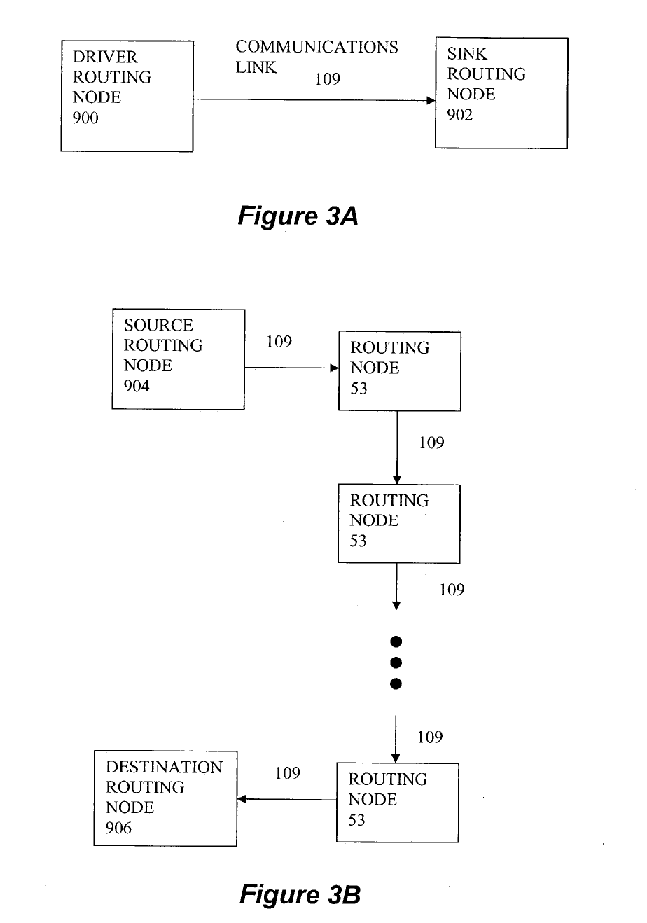

The simulation network 52 is comprised of communications links 109. FIG. 3A illustrates a single communications link and attached routing nodes. Each communications link 109 is connected to one or more driver routing nodes 62 which can send information across the communications link 109. Each communications link 109 is also connected to one or more sink routing nodes 62 which receive information. Those communications links 109 whose driver routing nodes 900 and sink routing nodes 902 cannot be changed after the logic circuit simulation configuration database 70 is presented to the mapper 80 are classified as fixed communications links. Those links whose driver routing nodes 900 or sink routing nodes 902 may be re-defined when the logic circuit simulation configuration database 70 is presented to the mapper 80 are classified as non-fixed communications links. When the mapper 80 compiles the logic circuit the logic circuit simulation configuration database 70 identifies the fixed communications links and the non-fixed communications links. During the compilation the mapper 80 determines the optimal driver routing nodes 900 and sink routing nodes 902 for the non-fixed communications links. This information is included in the download database 76. At compile time the mapper 80 also creates reconfiguration instructions 75 which define which communications links should be added, eliminated or altered before a simulation is run. Note that when a simulation begins the topology of the simulation network 52 is completely known.

FIG. 3B illustrates the use of multiple routing nodes 53 and communications links 109 to transfer information from a single source routing node 904 to a single destination routing node 906. During system operation a source routing node 904 creates a simulation network packet 289 (also referred to as a packet 289) and sends it to a set of destination routing nodes 906 via the simulation network 52 and other routing nodes 53. As a packet 289 is transferred from a source routing node 904 to a destination routing node 906 it will pass over a plurality of communications links 109. At each link the driver routing node 900 for that communications link 109 passes the packet 289 to one or more source routing nodes 904 for that link. A sequence of such communications links 109 will be referred to as a routing path from a source routing node 904 to a destination routing node 906. Once the circuit is mapped and the setup user 40 has reconfigured the system the entire set of communications links 109 which can be used to transfer a packet 289 from the source routing node 904 to any set of destination routing nodes 906 is known. This is true whether the fixed communications links or the non-fixed communications links of the simulation network 52 are used to transfer the data. Therefore, the mapper 80 can include this information in the download database 76. Also, the format of the packet 289 can be optimized to minimize size and to simplify the routing of the packet 289.

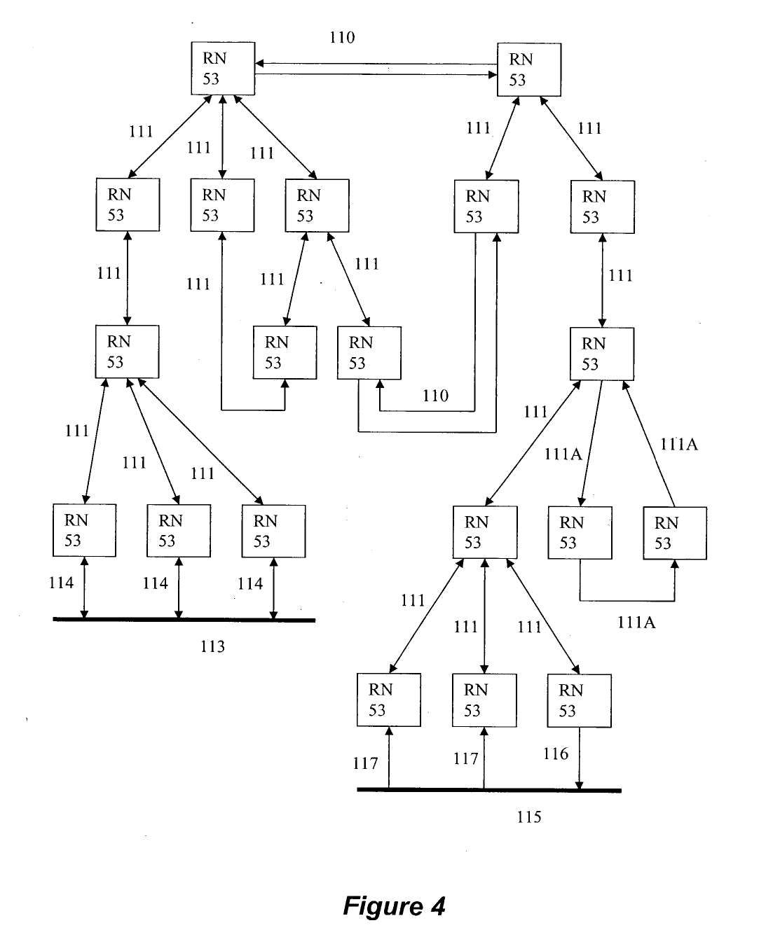

Any physical connection known in the state of the art may be used to implement the communications links 109. This includes buses, bi-directional links, and unidirectional links. These physical connections may employ single drive or differential drive signals. Further, the specific physical resource could be time multiplexed between different masters, dedicated to one master, or arbitrated for. The only requirement is that the physical medium be able to transfer a plurality of data. These links may also be arranged in any topology. FIG. 4 illustrates several preferred embodiments of communications links and their attached routing nodes 53 (A single routing node 53 is identified as RN 53 in FIG. 4). A pair of unidirectional communications links 110 is used to connect two of the routine nodes 53. A single point to point bi-directional link 111 is used to connect several pairs of routing nodes 53. An arbitrated bus 113 is used to communicate between a subset of routing nodes 53 which transfer packets 289 to and from the arbitrated bus 113 via bi-directional communications links 114.. A single master bus 115 allows one routing node 53 to send information, via a master link 116, to a set of other routing nodes 53 via slave links 117. A plurality of routing nodes 53 uses a loop of single unidirectional links 111A to pass data between themselves.

While preferred embodiments have been shown in FIG. 4 it should be apparent to one with skill in the art that any topology of communications links 109 may be constructed.

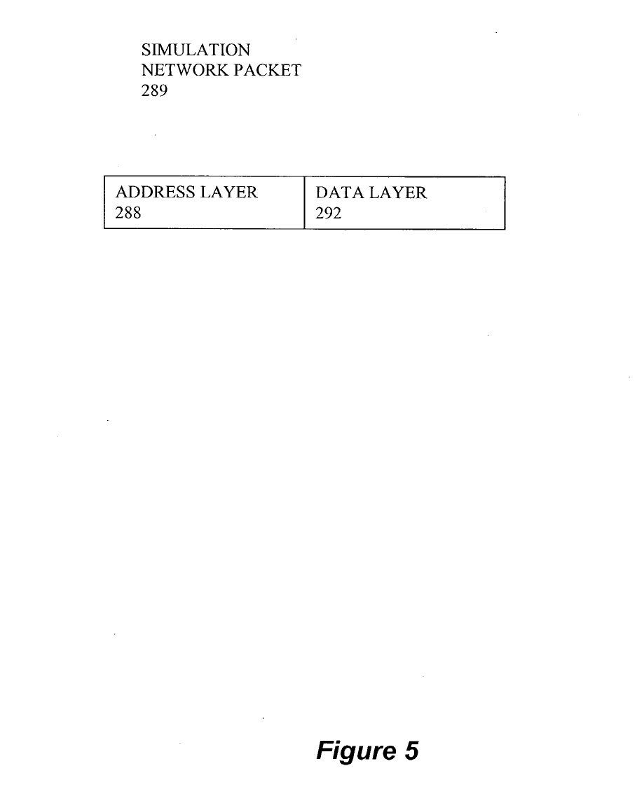

As shown FIG. 5, in one embodiment of the routing nodes 53, and simulation network 52, packets 289 which are sent from a source routing node 904 is partitioned into an address layer 288 and a data layer 292. The data layer 292 of a packet 289 contains any information which will be needed after the packet 289 reaches the destination routing nodes. The address layer 288 specifies the routing path through which a packet 289 will pass. The routing path to be used for each transfer is specified in the download database 76.

When a routing node 53 receives a packet 289 it examines the contents of the address layer 288 to determine if the routing node is in the set of destination routing nodes 906 and whether the packet 289 should be forwarded along a one or more routing paths to other destination routing nodes 906. If the address layer 288 indicates that the routing node 53 is a destination routing node 906 it is processed by that routing node 53. The processing may occur within the routing node 53 or the routing node 53 may pass the data portion of the packet 289 to an attached terminal node 54. If the routing node 53 is along a routing path from the source routing node 904 to a destination routing node 906 then the address layer 288 indicates which communications links 109 should be used to forward the packet 289 to other routing nodes 53. Before the packet 289 is forwarded the address layer 288 may be altered to remove information which is no longer needed, such as the portion of the routing path which has already been traversed. The address layer 288 may also be formatted so that subsequent routing nodes 53 along each routing path may easily examine the address layer 288. Note that a routing node 53 may simultaneously be a destination routing node 906 and lie on the routing path from the source routing node 904 to another destination routing node 906.

In a preferred embodiment the routing nodes 53 and terminal nodes 54 accept all packets 289 which are sent to them without waiting for any other network simulation packets 289 to arrive or for any internal updates to specific state stored within a terminal node 54 or state held within the routing node 53. A routing node 53 or terminal node 54 may delay acceptance of a packet 289 because of data bus contention or to complete other processing in progress. However, a routing node 53 or terminal node 54 will not wait for the arrival of some other packet 289. This prevents deadlock from occurring regardless of the network topology. If the resources of the destination routing node 906 are finite then it is the responsibility of the source routing node 904 to delay the transfer of packets 289 until resources are available. This can be done by any number of methods that are known in the state of the art. One example method is to have a fifo within the destination routing node 906 and to send, from the destination routing node 906, a flow control signal when the fifo fills. Another is to guarantee that the processing rate of packets 289 exceeds the maximum rate at which packets 289 may arrive. It is also possible to use packets 289 which contain flow control to indicate to a source routing node whether additional packets 289 can now be sent. There are other methods known in the state of the art.

Method counterparts to each of these embodiments are also provided. Other system, methods, features and advantages of the invention will be or will become apparent to one with skill in the art upon examination of the following figures and detailed description. It is intended that all such additional system, methods, features and advantages be included within this description, be with the scope of the invention, and be protected by the accompanying claims.

### Routing Nodes and Simulation Network: Tree Embodiment

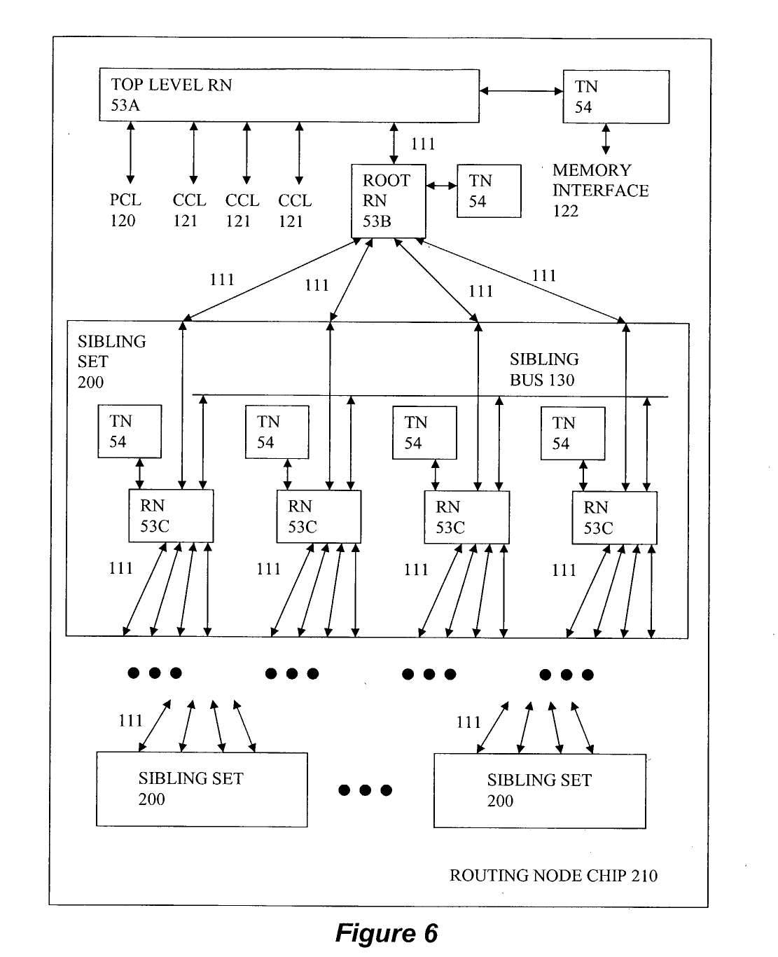

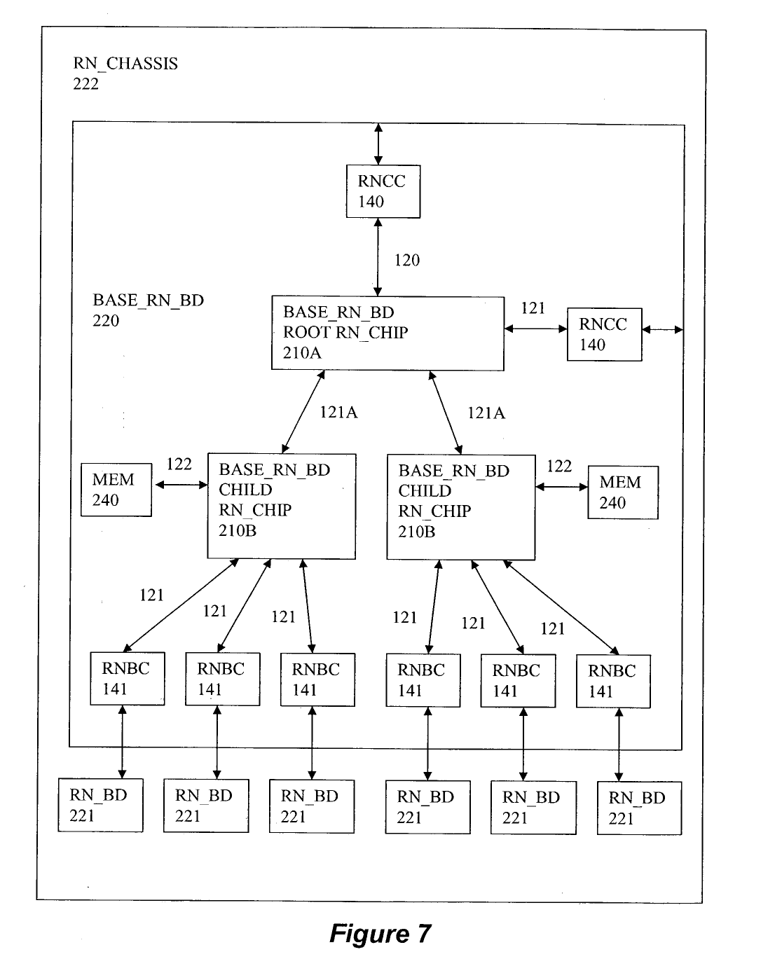

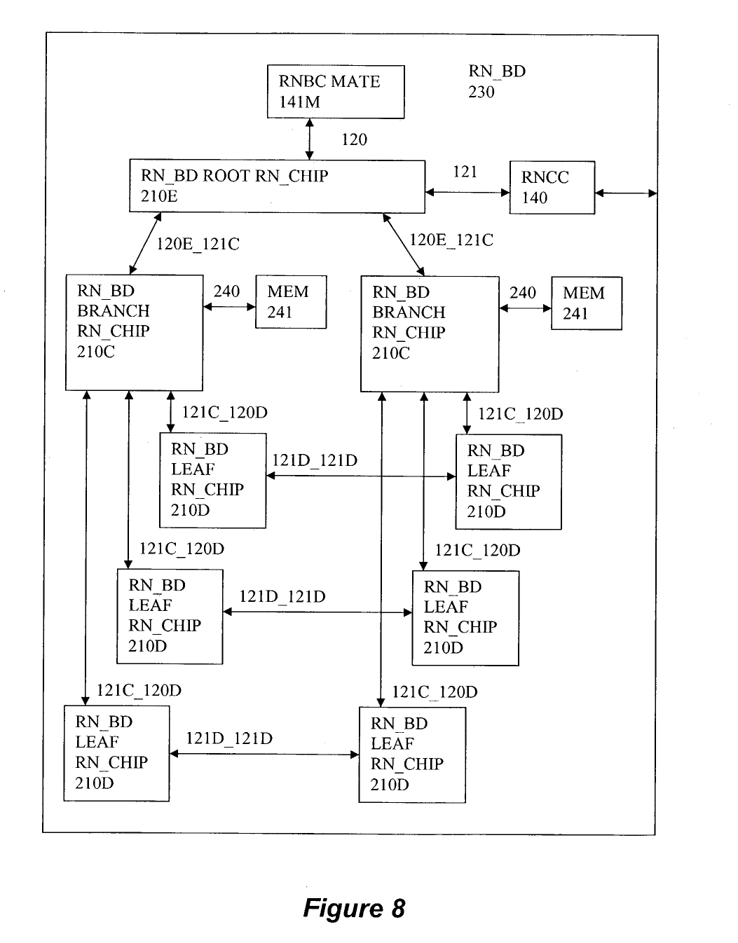

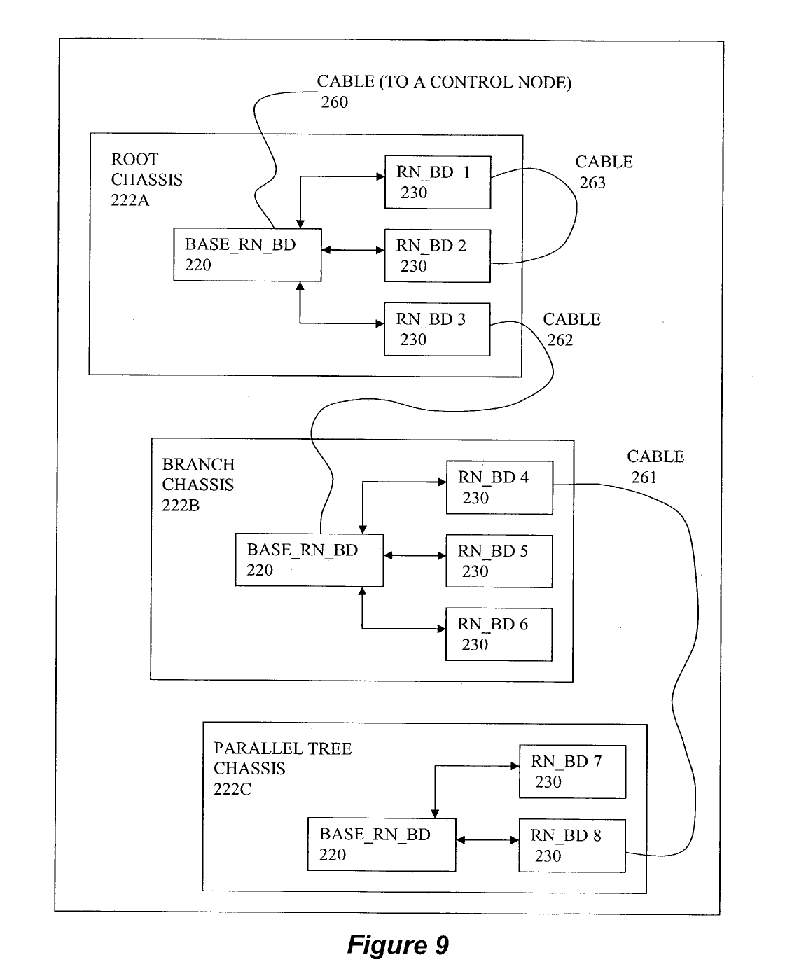

FIG. 6, FIG. 7, FIG. 8, and FIG. 9 illustrate the network topology used in a preferred embodiment of the routing nodes and simulation network 52. Also illustrated is the arrangement of terminal nodes and routing nodes.

FIG. 6 illustrates a routing node chip (RN-CHIP) 210 which is used in the preferred embodiment. (In FIG. 6 specific embodiments of routing nodes 53 are distinguished by their position within the routing node chip 210 by referring to them with different letter suffixes following the ‘53’. However, the internal functions supported by the routing node 53 are supported by all such routing nodes 53.) In FIG. 6 the terminal nodes 54 are labeled TN 54.

Within the routing node chip 210 is a top level routing node (top level RN) 53A. The top level routing node 53A is connected to four communications link interfaces: a single parent communication link interface (PCL or parent link) 120 or one of three child communication link interfaces (CCL or child link) 121. All communications between an RN-CHIP 210 and the rest of the logic circuit simulation system 50 take place over one of these four communications link interfaces. The PCL 120 and CCLs 121 can be configured to operate with one of two physical interfaces. The first configuration is as a pair of point to point interfaces designed to be driven across printed circuit board interfaces. The second configuration is as a pair of point to point interfaces designed to be driven across a cable. When the system is initialized in preparation for a simulation the top level routing nodes 53A determine for each PCL 120 and CCL 121 whether the PCL 120 or CCL 121 is driving across a printed circuit board or a cable. The top level routing node 53A also determines for each PCL 120 and CCL 121 whether the PCL 120 or CCL 121 is connected to a PCL 120 or a CCL 121 on the other end. This can be done by any number of means known in the state of the art, including configuration pins on the cable, configuration information in the download database 76 or a negotiation between top level routing nodes 53A. If two top level routing nodes 53A are connected via CCLs 121 they are considered to be peers. If two routing nodes are connected via PCLs 120 they are considered to be peers. If two top level routing nodes 53A are connected via a PCL 120 on one routing node and CCL 121 on the other top level routing node 53A then the top level routing node 53A which uses the PCL 120 is referred to as parent of the top level routing node 53A which uses the CCL 121 (which is the child). While the routing node chip 210 illustrated in FIG. 6 has four external communications links it is possible for other, similar embodiments, to have any number of communications links.

The top level routing node 53A is also connected, via a bi-directional communications link 111, to a root routing node (root RN) 53B which is internal to the routing node chip 210. The root RN 53B is connected to a sibling set 200 consisting of a plurality of child routing nodes 53C. The root RN 53B is connected to each routing node 53C in the sibling set 200 with a bi-directional communications link 111. Each routing node 53C in the sibling set 200 is then connected to four additional sibling sets 200. This structure is recursively repeated until all of the available resources in the routing node chip are consumed. The root routing node 53B and each routing node 53C within a sibling set 200 is also connected to a terminal node 54 (referred to as TN in FIG. 6 and subsequent figures). In addition there is a terminal node 54 which is attached to the top level routing node 53A and to a large block of memory via a memory interface 122. The simulation of the logic circuit is performed in these terminal nodes 54.

In the embodiment shown in FIG. 6 the sibling set 200 has 4 routing nodes 53C. However, a sibling set 200 may contain any number of routing nodes 53C. This structure forms a tree of nodes. It should be noted that the hierarchical structure of the tree is similar to the hierarchical structure of the majority of logic circuits. This is because the cost of routing resources within a typical logic circuit embodiment is similar to the cost of transferring data over the simulation network 52. Thus, the mapping of a logic circuit onto a tree structure will generally be quite tractable.

In addition to being connected to one parent routing node 53 and plurality of child routing nodes 53 each routing node 53C in a sibling set 200 is connected to the other routing nodes 53C in the same sibling set 200 with a non-fixed communications link, referred to as the sibling bus 130. Any of the routing nodes 53C attached to the sibling bus 130 may drive the bus. However, the mapper 80 may configure the sibling routing nodes 53C so that during a particular simulation only one of the attached routing nodes drives the sibling bus 130. All of the other sibling routing nodes 53C only receive information. Which sibling routing node 53C will drive the bus is determined by the mapper 80 at compile time. In one embodiment the mapper 80 determines which terminal node 54 will transfer the most data to the other terminal nodes 54 in the sibling set 200 and assigns the routing node 53C associated with that terminal node 54 to be the driver routing node 900 for the sibling bus 130 for the entire simulation. In another embodiment the mapper 80 identifies which terminal node 54 will transfer the most data to the other terminal nodes 54 in the sibling set 200 for selected subsets of processing and for each subset assigns the routing node 53C associated with that terminal node 54 to be the driver node for that subset of processing. Alternatively, the mapper 80 may indicate that the routing nodes 53C should arbitrate for control of the sibling bus each time they transfer a packet 289.

FIG. 7 illustrates an embodiment, referred to as an RN chassis 222, in which multiple routing node chips 210 are combined to form a larger accelerator 51. Within the RN chassis 222 is a BASE_RN_BD 220 which contains three RN_CHIPS 210 which are identified as a base_rn_bd root rn_chip 210A and two base_rn_bd child rn_chips 210B. The parent communications link 120 and one of the three child communication links 121 of the base_rn_bd root rn_chip 210A are configured to use a cable as their physical medium. The parent communication link 120 and the child communication link 121 are brought out of the chassis via routing node cable connectors 140 (referred to as RNCC 140 or RNCC connector 140 in FIG. 7 and subsequent figures).

The remaining two child communication links 121A of the base_rn_bd root rn_chip are configured to use a printed circuit card as their physical medium. These two links are connected to the two BASE_RN₁₃ BD child RN_CHIPs 210B. The PCL 120 of each BASE_RN_BD child RN_CHIP 210B is configured to use a printed circuit board as their physical medium and is connected to a CCL 121 of the BASE_RN_BD root RN chip 210A on the base_RN_BD 220.

All of the child communication links 121 of the two BASE_RN_BD child RN_CHIPS 210B are configured to use a printed circuit card as their physical medium. Each of these six child communication links 121 are brought to a routing node board connector 141 (referred to as RNBC in FIG. 7 and subsequent figures). In addition a memory 240 is attached to each of the base_rn _bd child rn_chips 210B, via the memory interface 122.

FIG. 8 illustrates an arrangement of RN_CHIPs 210 on an RN_BD 230. A single RN_BD 230 can be plugged into each of the six RNBC connectors 141 on the base_rn_bd 220 illustrated in FIG. 7. Each RN_BD 230 contains nine RN_CHIPS 210. These are one rn_bd root rn_chip 210E, two rn_bd child rn_chips 210C and six rn_bd leaf rn_chips 210D. The parent communication link 120 of the rn_bd root rn_chip 210E is configured to use a printed circuit board as its physical medium and is routed to an RNBC mate connector 141M which mates with the RNBC connector 141 on the base_rn_bd 220. One of the child links 121 on the rn_bd root rn_chip 210E is configured to use a cable as its physical medium and is routed to a routing node cable connector 140 (referred to as RNCC or RNCC connector). The other two child communications links 121 of the rn_bd root rn_chip 210E are configured to use a printed circuit board as their physical medium. Each of these child communications links is connected, via 121E_120C to a parent communications link 121 on each rn_bd branch rn_chip 210C. The memory interface 122 on the rn_bd root rn_chip is not used in this particular embodiment. All of the parent communication links 120 and child communication links 121 on each rn_bd_branch rn_chip 210C are configured to use a printed circuit card as their physical medium. Each of the child communication links 121 on each rn_bd₁₃ branch rn_chip 210C is connected, via 121C _120D, to a rn_bd leaf rn_chip 210D. The memory interface 122 on each rn_bd branch rn_chip is connected to an array of memory (mem 241). The parent communication link 120 of each rn_bd leaf rn_chip 210D is configured to use a printed circuit board as its physical medium and is routed to one of the child communication links 121 on a rn_bd_branch rn_chip 210B, via 120C₁₃ 121D. Two of the child communication links 121 on the rn_bd leaf rn_chips 210D are not used. The third CCL 121 of an rn_bd leaf rn_chip 210D is connected to the CCL 121 of another rn_bd leaf rn_chip 210D, via 121D_121D. These two rn_bd leaf rn_chips 210D are connected to different rn_bd branch rn_chips 210C.

To extend the configuration a cable can be added between any pair of RNCC connectors 140. The RNCC connectors 140 may be in the same rn_chassis 222 or a different rn_chassis 222. Because the tree structure can be extended indefinitely there is no limitation on expansion imposed by the implementation of the simulation network 52. The interface to the control nodes 57 within the simulation control and user interface 55 is made with one or more cables, each of which connects to an RNCC 140 connector. While this would typically be a single connection at the root of the tree of RN_CHIPs 210 a control node 53 may be connected to any RNCC connector 140.

The logic circuit simulation configuration database 70 used by the mapper 80 represents the combination of rn_bd cards 230, rn_chassis 222 and cables which the user has arranged. When the mapper 80 compiles the logic circuit it determines the optimal use of these resources and produces reconfiguration instructions 75 which specify the adjustments to the configuration which the setup user 40 should make before a simulation is begun. The mapper 80 considers communications links 109 which are connected to RNBC 141 or RNCC 140 to be non-fixed communications links. The reconfiguration instructions 75 may specify that rn_bds 230 be moved from one slot to another, or from one rn_chassis 222 to another. They may also specify that cables be moved to different RNCC connectors 140 or that additional cables be added between RNCC connectors 140.

FIG. 9 illustrates an example arrangement of cables connecting three rn_chassis 222, three BASE_RN_BDs 200, eight rn_bds 230, and cables 261. A cable 260 to a control node 57 is attached to the RNCC connector 140 on the base_rn_bd 220 of the root chassis 222A. The other end of the cable 260 is attached to simulation control and user interface 55. The cable 262 which connects RN_BD_3 230 to the base_rn_bd 220 of the branch chassis 222B extends the tree of routing nodes 53 within the accelerator 51. The cable 261 which connects RN_BD_4 230 and RN_BD_8 230 adds a parallel tree to the set of routing nodes 53. The cable 263 which connects RN_BD_1 and RN_BD_2 does not extend the tree. However, it provides additional communication links 109 over which simulation data may travel.

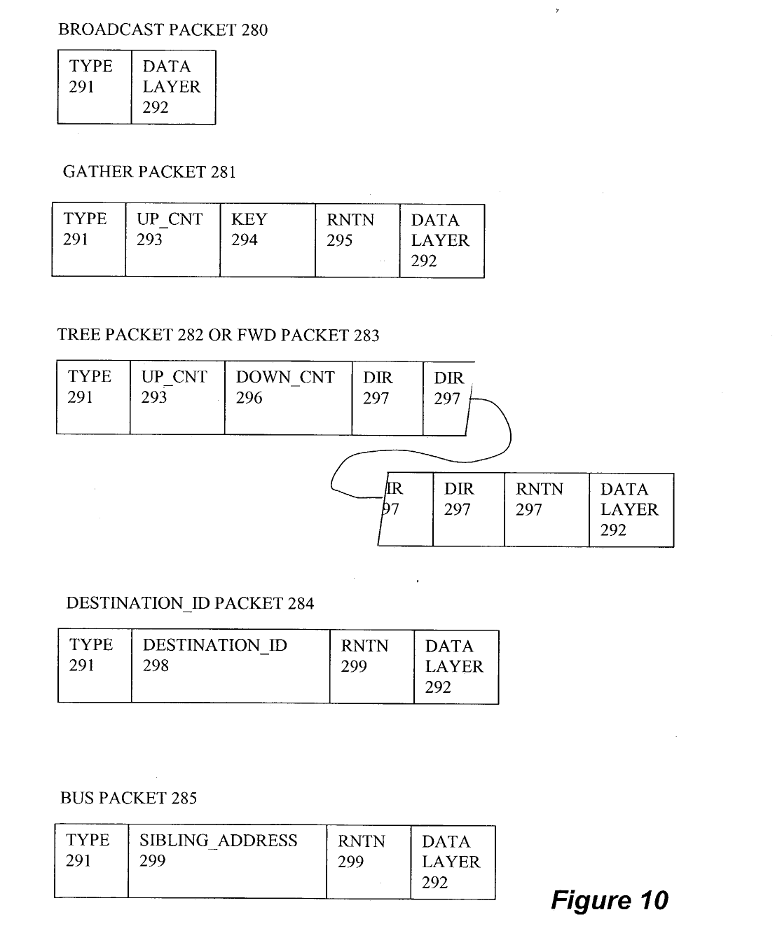

FIG. 10 illustrates a preferred embodiment of the packets 289 used in the accelerator 51. The address layer 288 is broken into fields. Each format shown in FIG. 10 illustrates the fields which are in the address layer 288, followed by the data layer 292. The type field 291 is the first in the packet 289 and indicates that the packet is one of the following types:

broadcast packet 280—used to send information to a plurality of routing nodes

gather packet 281—used to collect information from a plurality of a routing node

tree packet 282—used to send data to one node on the tree structure

bus packet 285—used to send data to one or more nodes on a sibling bus

destination_id packet 284—used to send data along a predetermined routing path

If the type 291 field indicates a broadcast packet 280 then no additional fields are required in the address layer 288. At compile time the mapper 80 determines a path from the control nodes 57 to each routing node in the system. It then places information in the download database 76 which indicates along which communication links 109 each routing node 53 should pass a broadcast packet 280. The communication links 109 along which broadcast packets 280 are sent are identified as broadcast_send links in the download database 76. When a routing node receives a broadcast packet 280 it forwards the packet along all communications links 109 identified as broadcast_send links in the download database 76. There may be multiple sets of broadcast_send links identified in the download database 76. In such cases the type field 291 identifies which set of broadcast_send links should be used to forward the broadcast packets 280.

If the type field 291 indicates a gather packet 281 the type field 291 is followed by an up-cnt field 293 and a key field 294, and an RNTN field 295. The communication links 109 along which gather packets 281 are sent are identified as gather send links in the download database 76. The communication links 109 along which gather packets 281 are received are identified as gather_receive links in the download database 76. It is possible to have multiple sets of gather_receive links and gather_send links. In such cases the type field 291 identifies which set of gather_receive links and which set of gather_send links should be used during the processing of a particular key.

The routing node 53 maintains a gather database which maps a value in the key field 294 to a vector which contains one entry for each gather_receive link. In the preferred embodiment there is only one entry in this database. However, any number of entries, each associated with a separate key value, can be supported. It is the responsibility of the terminal nodes or routing nodes which originally send the gather packet 281 to coordinate in order to prevent an over-subscription of this resource. This may be done by communication which takes place during system operation. In the preferred embodiment such over-subscription is prevented at compile time by the mapper 80.

When a routing node 53 receives a gather packet 281 it uses the key to create or add to an entry in the gather database. The vector entry which corresponds to the gather_receive link along which the gather packet 281 was received is set to indicate the receipt of the packet. If the vector then indicates that the gather packets 281 with the same key value have been received along all gather_receive links then the routing node examines the up_cnt field 293 in the packet. If the up_cnt field 293 is non-zero then the routing node 53 will decrement the up_cnt field 293 and forward the packet along all of the gather_send links. Otherwise, the up_cnt field 293 is zero, and the destination of the gather packet 281 is the routing node 53 or one of the terminal nodes 54 attached to the routing node 53. The routing node 53 examines the RNTN field 295 of the gather packet 281 to determine the destination. If the packet is for the routing node 53 it is processed by that routing node 53. If the gather packet 281 is destined for a terminal node 54 then the RNTN field 295 identifies which terminal node 54 (if more than one is present) and the gather packet 281 is forwarded to the terminal node 54.

If the type field 291 indicates a tree packet 282 the type field 291 is followed by an up-cnt field 293, a down_cnt 296 field, and a series of dir fields 297, and an RNTN field 295. A routing node 53 which receives such a tree packet 282 examines the up_cnt. If the up cnt is non-zero then the up_cnt is decremented and the packet is passed out the parent communication link. If the up_cnt is zero then the down_cnt field 296 is examined. If the down_cnt field 296 is zero then the RNTN field 295 is examined to determine if the routing node 53 or one of the terminal nodes 54 is the destination. If the routing node 53 is the destination then the data layer 292 of the packet is processed. If one of the terminal nodes 54 attached to the routing node 53 is the destination then the data layer 292 of the packet is forwarded to the terminal node 54 specified by the RNTN field 295. If the down_cnt field 296 is not zero then the next dir field 297 is removed from the tree packet 282 and the tree packet 282 is passed out the child communications link 121 specified by the removed dir field 292.

If the type field 291 indicates a destination_id packet 284 the type field 291 is followed by a destination_id field 298. Each routing node 53 contains a routing associative map. The key to the routing associative map is a destination_id 298 and the association is a subset of routing nodes 53 which are attached to the routing node 53 in the simulation network 52. This subset may also include the routing node 53 itself. When a routing node 53 receives a destination_id packet 284 it forwards the destination id packet 284 to the subset of routing nodes 53 associated with that destination_id 298 in the routing associative map. In addition, if the routing node 53 is in the subset of routing noes 53 then the routing node 53 also processes the destination_id packet 284. The size of the routing associative map is finite. At compile time the mapper 80 selects a finite number of routing paths along which packets may be passed using a destination_id address layer. For each routing path the mapper 80 assigns a destination_id 298 for use by all routing nodes 53 along that routing path. The mapper 80 further supplies, via the download database 76, the information required by each routing node 53 on the routing path to initialize its own routing associative map with the appropriate subset of routing nodes 53 for each destination_id. Note that two routing paths may be completely disjoint, meaning that there is no routing node 53 which appears on both routing paths. In this case the same destination_id 298 may be used by both routing paths. The routing nodes 53 on the first routing path have the links in the routing associative map which are associated with that path. The routing nodes 53 on the second routing path have the links in the routing associative map which are associated with that path. This increases the number of routing paths which may utilize a specific value of the destination_id 298.

If the type field 291 indicates a bus packet 285 the type field 291 is followed by a sibling address field 299 and an RNTN field 295. A bus packet 285 is only sent between routing nodes 53 which sit on a communications link 109 which is a bus. When a routing node 53 receives such a packet it examines the sibling_address field 299. If the sibling_address field 299 specifies that the routing node 53 is the destination routing node 906 then the RNTN field 295 is examined to determine if the routing node 53 or one of the terminal nodes 54 attached to the routing node 53 should process the packet 289. If the routing node 53 should process the packet 289 then the data layer 292 of the packet is processed. If one of the terminal nodes 54 attached to the routing node 53 should process the packet 289 then the data layer 292 of the bus packet 285 is forwarded to the terminal node 54 specified by the RNTN field 295.

In addition to specifying the terminal node 54 or routing node 53 which should process a packet 289 the RNTN field 295 of any packet 289 may specify that the data layer 292 of a packet 289 contains another complete packet 289. The routing node 53 which is the destination routing node 906 of the packet 289 discards the entire address layer 288 of the original packet 289. It then interprets the data layer 292 of the original packet 289 as though it were an entirely new packet 289.

While the preferred embodiment uses the particular packet formats described here it should be noted that any packet formats which allow routing nodes to 53 transfer packets over the simulation network 52 may be used. By separating the address layer 288 and data layer 292 of a packet a wide variety of routing node topologies may be supported.

Method counterparts to each of these embodiments are also provided. Other system, methods, features and advantages of the invention will be or will become apparent to one with skill in the art upon examination of the following figures and detailed description. It is intended that all such additional system, methods, features and advantages be included within this description, be with the scope of the invention, and be protected by the accompanying claims.

### Routing Nodes and Simulation Network: Sheet Embodiment

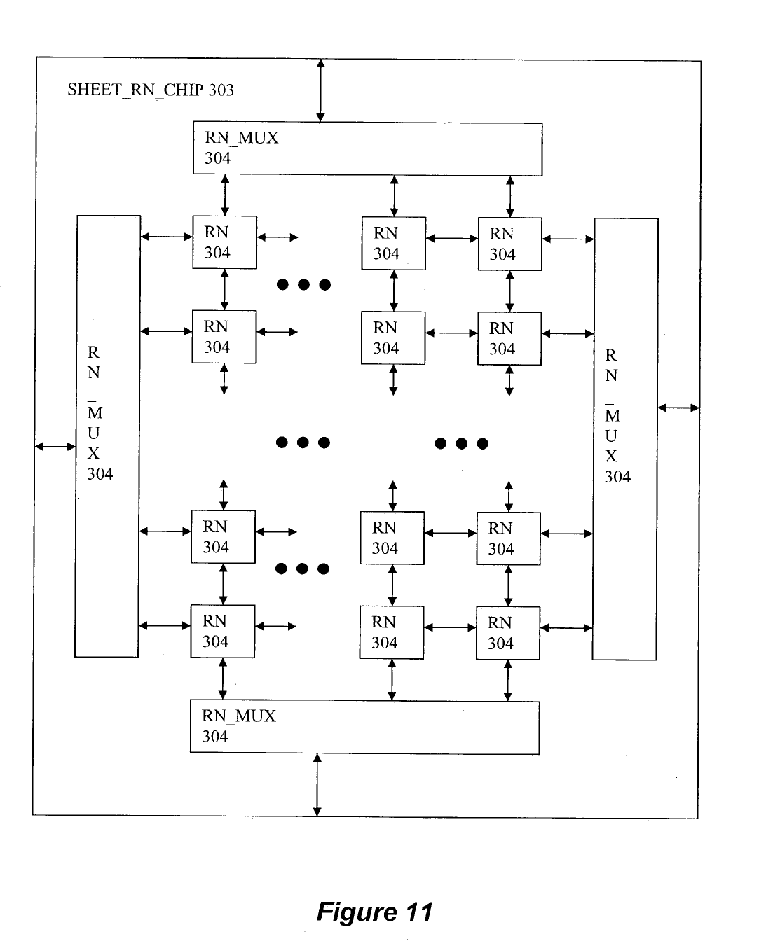

FIG. 11 illustrates an alternative topology of routing nodes within a SHEET_RN_CHIP 303. In this embodiment the routing nodes 304 are arranged in a rectangular array. The four external connections correspond to the PCL 120 and CCL 121 connections described in the tree embodiment. In addition, the tree packet 282 is altered in two ways. First, the up-cnt field 293 is removed. Second, each dir field 297 specifies one of the four adjacent routing nodes 304 attached to a particular routing node 53.

### Terminal Nodes and Semaphores

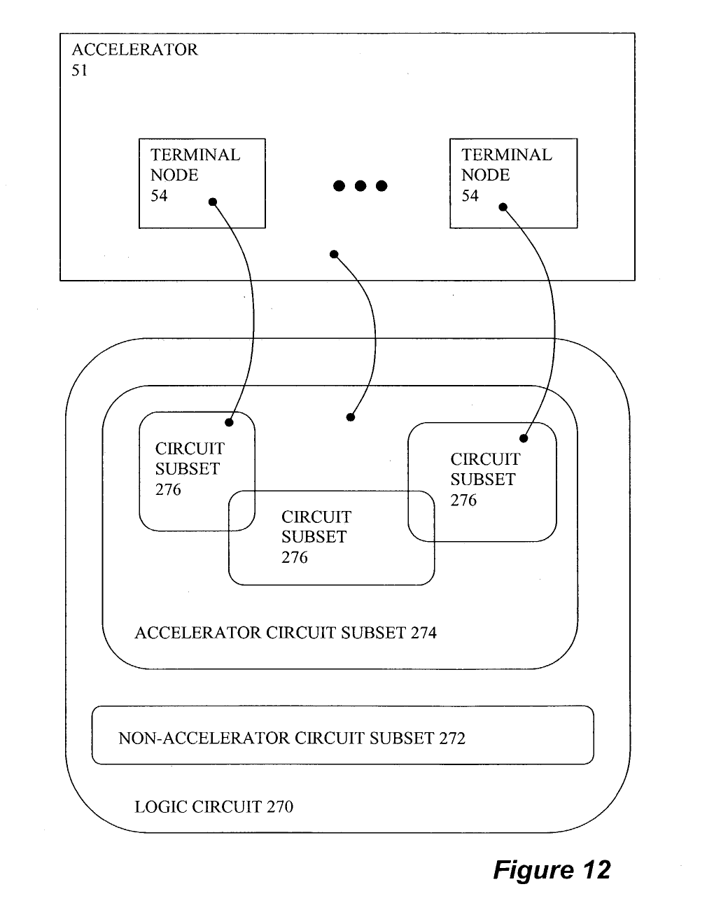

FIG. 12 illustrates the mapping of a logic circuit 270 onto an accelerator 51. Each terminal node 54 simulates a portion of the logic circuit 270 when a simulation is run. This portion will be referred to as a circuit subset 276. Each circuit subset 276 is mapped onto one terminal node 54. Note that a portion of the logic circuit 270 may be contained in multiple circuit subsets 276, and therefore will be mapped onto multiple terminal nodes 54. The collection of all circuit subsets 276 loaded into all terminal nodes within the accelerator 51 is referred to as the accelerator circuit subset 274. The portion of the logic circuit 270 which is simulated by devices other than the accelerator 51 is the non-accelerator circuit subset 272.

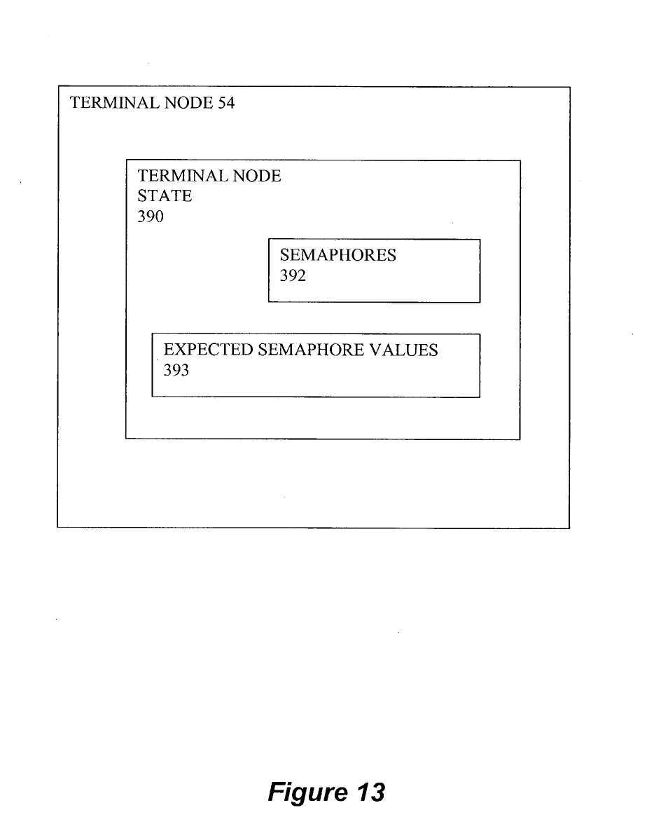

As illustrated in FIG. 13 each terminal node 54 contains terminal node state 390. Terminal node state 390 is all state required to simulate its circuit subset 276 during a simulation. The terminal node 54 also contains storage for a set of semaphores 392, and expected semaphore values 393 which are used to coordinate activities with other terminal nodes 54 during a simulation. The terminal node 54 also contains storage for any other state required to supply results or status during a simulation.

The circuit subset 276 for each terminal node 54 is determined by the mapper 80 at compile time. There are methods known in the art for partitioning logic circuits. The mapper 80 also, at compile time, assembles all of the information required by a terminal node 54 to perform the operations required to simulate the circuit subset 276 which has been mapped onto it. This includes allocation of storage for data structures which represent the circuit subset 276, and semaphores 392, and expected semaphore values 393, required for coordination with other terminal nodes 54 and any other terminal node state 390 required to simulate the circuit subset 276 and return results or status. The exact form of this information will depend on the particular implementation of the terminal node 54. For example, if terminal node 54 is implemented with a microcoded engine or general purpose processor then the information required would consist of the instructions to be executed by the microcoded engine or processor at each step of the simulation. Alternatively, if a terminal node 54 is a table driven state machine then the contents of the table would be constructed by the mapper 80. Alternatively, if a portion of the terminal node 54 were implemented with an FPGA then the directives for the processing elements would include the image to be downloaded into the FPGA. This information is then placed into the download database 76.

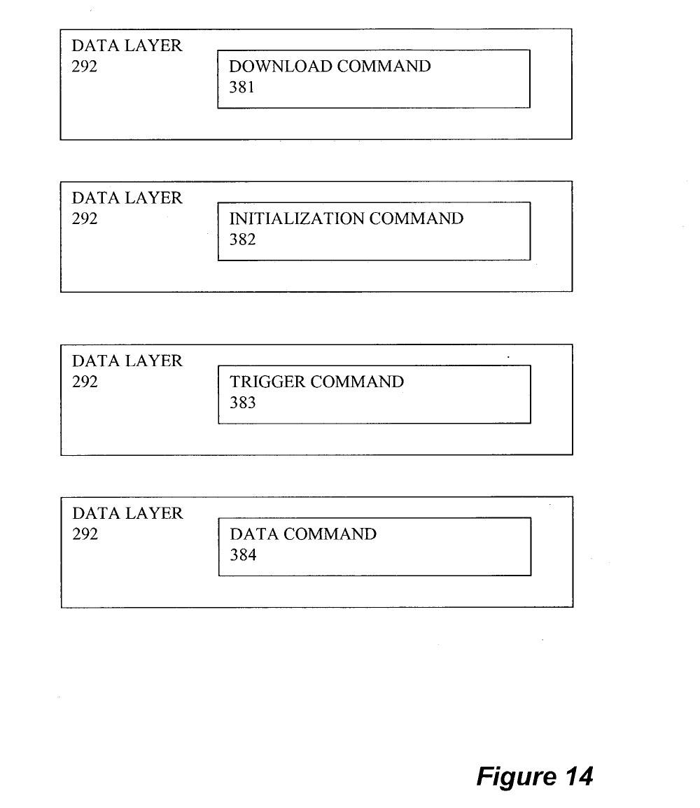

Terminal nodes 54 receive packets 289 which are forwarded by a routing node 53. The information received by a terminal node 54 is referred to as a command. Each command is contained within the data layer 292 of a network simulation packet 289 which is transferred to a routing node 53. After a destination routing node 906 receives a packet 289 the destination routing node 906 forwards the data layer 292 of the packet to the terminal node 54 specified in the address layer 288 of the packet. As shown in FIG. 14, in a preferred embodiment the commands received by a terminal node 54 are classified as follows:

1) download commands 381

2) initialization commands 382

3) trigger commands 383

4) data commands 384

The download commands 381 are used to transfer the information in the download database 76 to terminal nodes within the accelerator. The download database 76 may contain download commands 381 or it may hold the data in some other format. When the user provides a simulation start directive the control nodes 57 read the download database 76 and, if not already done by the mapper 80, reformats the information in the download database 76 into download commands 381. The download commands 381 are transferred to each terminal node 54 via the routing nodes 53 and simulation network 52. When the download command 381 is received by the terminal node 54 from a routing node 53 the terminal node 54 initializes the appropriate data structures, state, flips flops, and other terminal node state 390 within the terminal node 54.

When the user supplies a simulation initialization directive the control nodes 57 read the initialization database 78. If necessary the control nodes 57 reformats the information in the initialization database 78 into initialization commands 382 for the terminal nodes 54. These initialization commands 382 contain the initial values of simulation signals, semaphores 392, expected semaphore values 393, or other terminal node state 390. The commands are transferred to each terminal node 54 via the routing nodes 53 and simulation network 52. When a data initialization command 382 arrives at a terminal node 54 it is accepted and the values of the specified storage elements are initialized to the values specified in the initialization command 382.

During the simulation the simulation control and user interface 55 sends trigger commands 383 and data commands 384 to terminal nodes 54, via the routing nodes 53, and simulation network 52. When a terminal node 54 receives a trigger command 383 it examines the trigger command 383 to determine what processing is being requested and then proceeds with the processing. Trigger commands 383 can correspond to any event in a simulation. Examples include the transition of a clock signals from low to high, a change in the value of the output of a combinatorial circuit element, or a request for status or results from a simulation user 41. The processing of a trigger command 383 includes any activity required to update the values of the semaphores 392, expected semaphore values 393, and simulation signal values and other terminal node state 390 associated with the circuit subset 276 which was mapped to that terminal node 54.

During processing of a trigger command 383 the terminal node 54 also transfers information regarding the state of the circuit subset 276 or the progress of the simulation to other terminal nodes 54 or to simulation control and user interface 55. The information transferred includes the values of the semaphores 392, expected semaphore values 393, and simulation signal values and any other terminal node state 390 which may be required by simulation control and user interface 55, routing nodes 53, or other terminal nodes 54. In particular, any new values of the output signals of the accelerator circuit subset 276 are transferred to simulation control and user interface 55. Information may be transferred using data commands 384 or trigger commands 383 which are encapsulated within simulation network packets 289. Depending on the particular embodiment of the routing node 53 and the terminal node 54 either the terminal node 54, or the routing node 53, or a combination of both the terminal node 54 and the routing node 53 may assemble a particular simulation network packet 289. These packets 289 are then routed to other terminal nodes 54, routing nodes 53, or control nodes 57, via the simulation network 52. In a preferred embodiment of the routing nodes 53 assembling the packet 289 consists of adding an address layer 288 to a data layer 292 supplied by a terminal node 54.

Also during processing of a trigger command 383 the terminal node 54 may maintains expected semaphore values 393 for each of the semaphores 392. An expected semaphore value 393 may derived within the terminal node 54, or it may be sent to the terminal node via a trigger command 383 or data command 384, or it may be updated by any means which is used to update terminal node state 390. The terminal node 54 may compare the value of one or more semaphores 392 with an expected semaphore value 393 and suspend the processing if the value of a semaphore 392 is not the same as the expected semaphore value 393. Once processing is suspended the terminal node 54 waits until the value of the semaphore 392 has been updated and now matches the expected semaphore value 393. When the value of the semaphore 392 is updated and matches the expected semaphore value 393 then processing proceeds.

A second trigger command 383 may arrive while the processing for a first trigger command 383 is taking place. The handling of this second trigger commands 383 depends on the embodiment of the terminal node 54. One possibility is that the terminal node 54 will complete processing of the first trigger command 383 before examining the second trigger command 383. Alternatively, the second trigger command 383 may be examined immediately and processing of the second trigger command 383 may begin if it has higher priority than the first trigger command 383. Any method known in the state of the art to share processing resources between two requests is possible. The order in which the trigger commands 383 which have arrived at a terminal node 54 are processed is dependent on the functions performed by that terminal node 54 and the processing performed in response to the trigger commands 383 which the terminal node 54 receives. The priority of each trigger command 383 may be included in the information sent with the download commands 381 or initialization commands 382. It is also possible to indicate the priority of a trigger command 383 within the trigger command 383 itself.

The data commands 384 received by a terminal node 54 contain the values of a plurality of semaphores 392 or simulation signals, flip flops, rams, or other storage elements or other terminal node state 390. When a terminal node 54 receives a data command 384 it immediately updates the specified terminal node state 390 with the values specified in the data command 384. This activity is performed in parallel with the processing of trigger commands 383. For example, if a terminal node 54 has suspended the processing of a trigger command 383, pending the arrival of a semaphore value 392, then the semaphore value 392 may be updated with a data command 384 sent from another terminal node 54. Once the update occurs then processing of the trigger command 383 may continue.

Note that there are other ways to classify the commands sent, via packets, over the simulation network 52 besides the classes of download commands 381, initialization commands 382, trigger commands 383, and data commands 384. What is key to the invention is that there are two types of commands which are sent during a simulation. The first triggers simulation activity within the terminal node 54. The second passes data which is accepted and results in terminal node state 390 updates which occur in parallel with other processing within the terminal node 54. While the source of the commands has been described as the routing nodes 53 or simulation control and user interface 55 the commands may come from any device or circuit.

In addition to being connected to routing nodes 53 a terminal node 54 may be connected to I/O interfaces 62. The exact function performed on the other side of the I/O interface depends on the particular embodiment of the terminal node 54. During the processing of a trigger command 383 the terminal node 54 may transfer data over the I/O interface. The terminal node 54 may also collect data via the I/O interface 62. A terminal node 54 may also send or receive data via the I/O interface 62 in the background while processing trigger commands 383. The terminal node 54 may also examine the data received over the I/O interface 62 and use this information to assemble trigger commands 383 or data commands 384.

A terminal node 54 may also be connected to a co-simulator 60. During the processing of a trigger command 383 the terminal node 54 may transfer data over the co-simulator interface. The terminal node 54 may also collect data via the co-simulator interface. Transfer across the co-simulator interface may also occur in the background while processing trigger commands 383. The terminal node 54 may also examine the data received over the co-simulator interface and use this information to assemble trigger commands 383 or data commands 384.

While the terminal nodes 54 have been described here as a separate entity than the routing nodes 53 it will be apparent to one with skill in the art that a single module could perform the functions of both the routing node 53 and the terminal node 54.

### Semaphore Usage

One embodiment of semaphore use is to notify a terminal node 54 that terminal node state 390 within the node has been updated and is available for use. This embodiment will be explained within the context of a signal value within the accelerator circuit subset 276. However, the techniques discussed may be applied to any terminal node state 390.

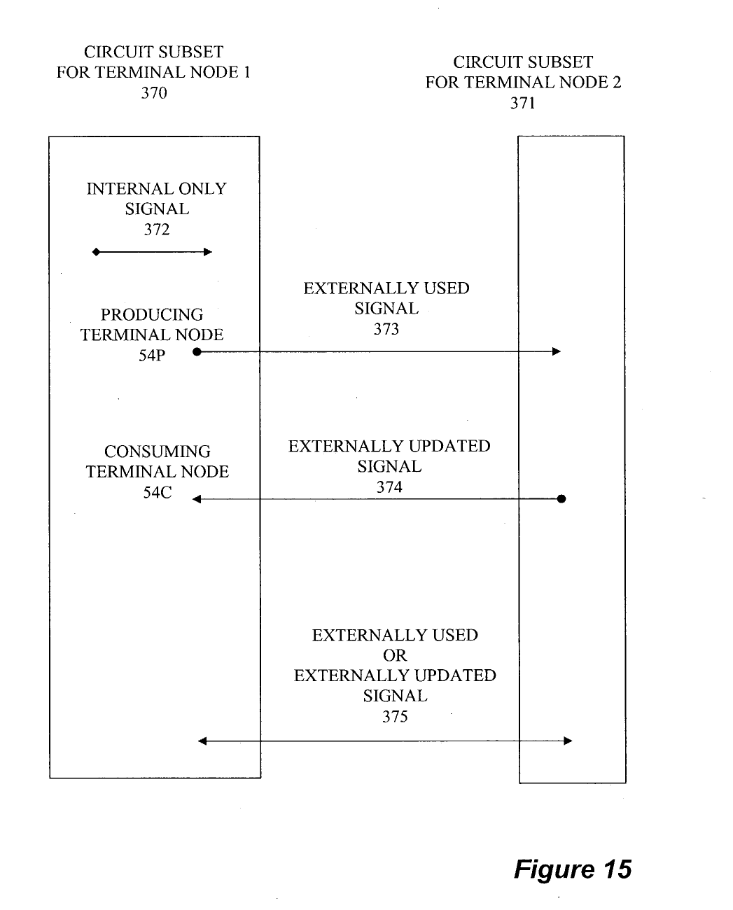

The circuit subset 276 which is mapped onto one terminal node 54 may contain signals which are also part of a circuit subset 276 mapped onto other terminal nodes 54. These signals may be input signals, output signals or bi-directional signals. To simulate the entire circuit the terminal nodes 54 must pass the values of such signals between each other during simulation. To accomplish this the signals which are part of a circuit subset 276 are divided into the following four categories for each terminal node 54 and for each trigger command 383 by the mapper 80 when the circuit is mapped. As illustrated in FIG. 15 these categories are:

1) internal only signals 372

2) externally used signals 373 (output signals)

3) externally updated signals 374 (input signals)

4) externally used or externally updated signals 375 (bi-directional signals)

These categories are illustrated in FIG. 15. There is a circuit subset for terminal node 1 370 and a circuit subset for terminal node 2 371 which represent two circuit subsets 276 which are mapped onto two terminal nodes 54. FIG. 15 how signals would be classified for the terminal node 54 onto which the circuit subset for terminal node 1 370 is mapped.

If a signal is an internal only signal 372 then the terminal node 54 into which it is mapped can update and use the signal value without communicating with any other terminal node 54.

If a signal is an externally used signal 373 for a particular trigger command 383 then the terminal node which updates the value of the signal is considered to be the producing terminal node 54P. The externally used signal 373 is required by one or more consuming terminal nodes 54C to perform the processing for a that trigger command 383. When the trigger command 383 is processed each terminal node 54 determines whether it is currently driving the signal, and is therefore going to determine the new value of the signal. The terminal node 54 which will supply the new signal value will be referred to as the producing terminal node 54P. The producing terminal node 54P transfers the value of the externally used signal 373 to the consuming terminal nodes 54C which require the signal value. This is done by transferring the value of the signal to the routing node 53 which is attached to the producing terminal node 54P. Either the routing node 53 or the producing terminal node 54P may format the data into a data command 384. Either the routing node 53 or the producing terminal node 54P may construct the address layer 288 of the packets 289 which encapsulate the data commands 384. The location of formatting and construction depends on the particular embodiment of the terminal nodes 54 and routing nodes 53. The address layer 288 of each of the packets 289 contains the routing path to the consuming terminal nodes 54C which require the value of the externally used signal 373. When the packet 289 arrives at a consuming terminal node 54C the data layer 292 of the packet 289 is examined to determine which signals are to be updated and the new values of the signals. The signal values are immediately updated.

A semaphore 392 is associated with each of the externally updated signal values 374 which are sent from a particular producing terminal node 54P to a plurality of consuming terminal nodes 54C. A single semaphore 392 may be associated with multiple signal values or with a single signal value. After all of the signals values associated with a particular semaphore 392 have been transferred to the consuming nodes the value of the semaphore 392 is updated. This may be done with a separate data command 384 which identifies the semaphore 392 and its new value which is sent in a separate packet 289. Alternatively, a new value of a semaphore 392 may be included in a data command 384 which updates signal values. There are many ways known in the state of the art to insure that the signal value updates and the updates to semaphores 392 remain ordered so that the update of the semaphore 392 occurs after the updates of the signal values. For example, in some systems packets which are sent along the same routing path in the simulation network 52 remain ordered and arrive in the order in which they were sent. In such a system if all of the data commands 384 which update signal values associated with a semaphore 392 are transferred using the same routing path before transferring the associated semaphore 392 along the same routing path then this insures that the update to the semaphore 392 occurs last. Alternatively, the consuming terminal node 54C may count the number of signal values it has updated. The consuming terminal node 54C updates the semaphore 392 only when the count indicates that all signal values have been updated. A third alternative is to include the update to the semaphore 392 in the same command used to transfer the last signal value update. Other methods will be apparent to one with skill in the art.

Associated with each semaphore 392 is an expected semaphore value 393. This expected semaphore value 393 is known to both the producing terminal nodes 54P and the plurality of consuming terminal nodes 54C. One method for communicating the expected semaphore value 393is to send an expected semaphore value with the trigger commands 383 sent to the producing terminal nodes 54P and consuming terminal nodes 54C. When a semaphore 392 is updated it is set to the expected semaphore value 393. The number of unique expected semaphore values 393 which are used depends on the particular embodiment of terminal nodes 54, routing nodes 53 and the algorithm used to update the semaphores 392 and expected semaphore values 393. For example, it is possible to use a fixed sequence of semaphore values. Suppose a trigger command 383 is sent corresponding to each positive clock edge in a single clock system. Then, the semaphore value used can toggle between an ‘on’ value and an ‘off’ value. In this case the value of the semaphore 392 may be omitted from the data command 384 which updates the semaphore 392.

Before a consuming terminal node 54 uses an externally updated signal 374 it first checks the value of the semaphore 392 associated with that signal. If the value is the expected semaphore value 393 associated with that semaphore 392 then the update to the value of the externally updated signal 374 has occurred. Thus, the simulation processing done within the terminal node 54 can proceed immediately. However, if the value of the semaphore 392 does not match the expected semaphore value 393 then processing which requires that signal is postponed. It may be possible for the terminal node 54 to conduct other processing (either associated with that trigger command 383 or with another trigger command 383 ) while waiting for an update to the value of the semaphore 392. Only after the value of the semaphore 392 matches the expected semaphore value 393, indicating that the new value of the externally updated signal 374 is available, will the processing which involves that signal continue.

For those signals which are an externally used or externally updated signal 375 the terminal nodes 54 which have that signal in their circuit subset 276 must first determine whether they are driving the signal. If they are then it is treated as an externally used signal 373. Otherwise the signal is treated as an externally updated signal 374.

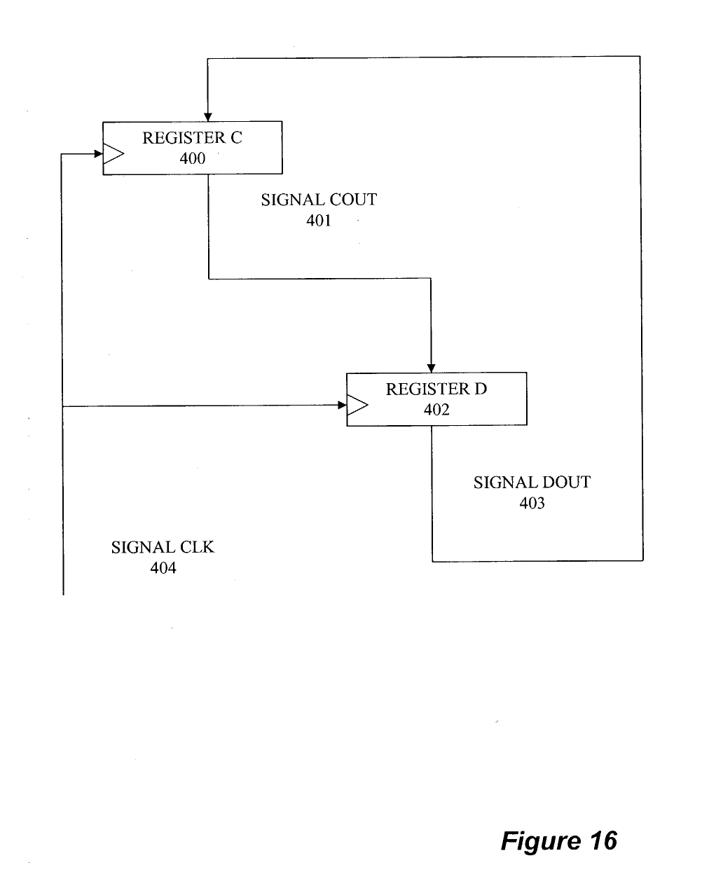

In another embodiment of semaphore use the premature transfer of terminal node state 390 is prevented. An example of such a situation is illustrated in FIG. 16. The register C 400 is part of a circuit subset 276 which has been mapped onto a terminal node 54 denoted as ‘terminal node C’. The register D 402 is part of a circuit subset 276 which has been mapped onto a terminal node 54 denoted as ‘terminal node D’.

At some point during a simulation terminal node C and terminal node D both receive a trigger command 383 which indicates that the signal CLK 404 has transitioned from low to high. As part of the processing of this trigger command 383 terminal node C should update the value of signal AOUT 401 by replacing it with the original value of signal DOUT 403. Similarly, terminal node D should update the value of signal DOUT 403 by replacing it with the original value of signal COUT 401. In addition, terminal node D will send the new value of signal DOUT 403 to terminal node C with a data command 384 and terminal node C will send the new value of signal COUT 401 to terminal node D with a data command 384. If care is not taken these events may occur in the following order:

1) the value of signal DOUT 403 is updated and transferred, using a data command, to terminal node C

2) terminal node C receives the data command 384 and updates the value of its copy of signal DOUT 403

3) terminal node C updates the value of signal COUT 401, using the new value of signal DOUT 403

This results in an incorrect value for COUT 401 after processing of the trigger command 383 is completed.

To properly serialize the updating of the value of signal DOUT 403 which is stored in terminal node C a semaphore 392 associated with signal DOUT 403 is stored in terminal node D. After terminal node C updates the value of signal COUT 401 it transfers the expected semaphore value 393 associated with signal DOUT 403 to terminal node B, using a data command 384. Before transferring the new value of signal DOUT 403 to terminal node C, terminal node D checks the value of the semaphore 392 associated with signal DOUT 403. Terminal node D does not transfer the new value of signal DOUT 403 until the value of the semaphore value 392 associated with signal DOUT 403 matches the expected semaphore value 393, indicating that terminal node C has completed its use of the original value of signal DOUT 403.

While signal values have been used to illustrate semaphore usage it is possible to order any two events within the accelerator 51 by using semaphores 392 and expected semaphore values 393.

Method counterparts to each of these embodiments are also provided. Other system, methods, features and advantages of the invention will be or will become apparent to one with skill in the art upon examination of the following figures and detailed description. It is intended that all such additional system, methods, features and advantages be included within this description, be with the scope of the invention, and be protected by the accompanying claims.

### Logic Loop Elimination

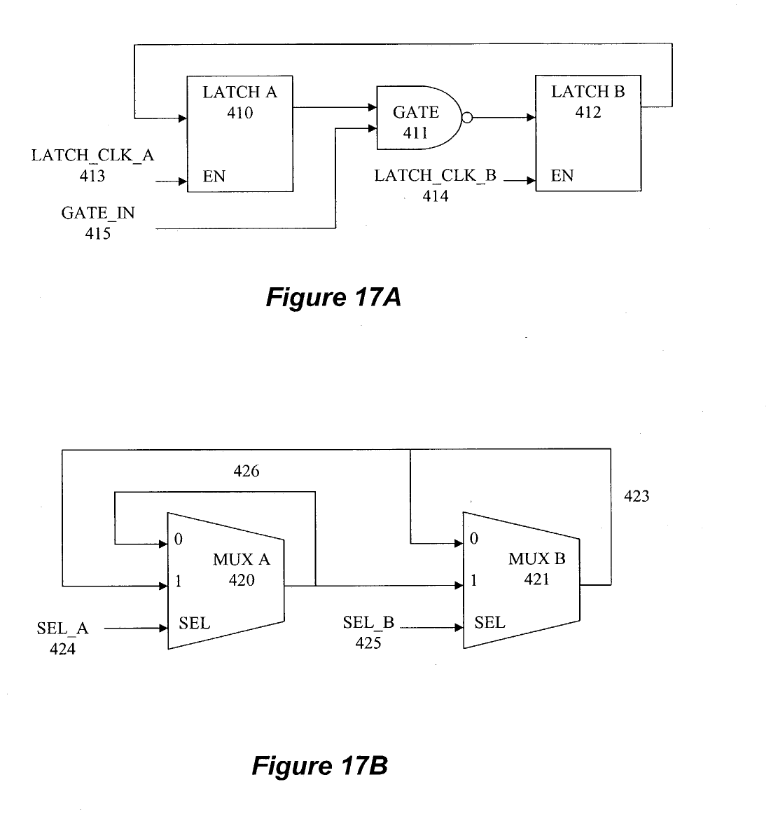

A logic loop is a path from the output of a given latch or combinatorial gate, through other latches or combinatorial logic, back to the input of the given latch or combinatorial gate. On example of such a loop is illustrated in FIG. 17A. In the top example the logic loop is the path from the output of LATCH A 410, through GATE 411, through LATCH B 412 and to the input of LATCH A 410. If the enable for a latch is asserted it is considered to be open and the output of the latch takes on the value at the input of the latch. If both LATCH A 410 and LATCH B 412 are open the circuit may never attain a stable state. In another example, illustrated in FIG. 17B there is a loop from the output of MUX A 420, through MUX B 421 and back to the input of MUX A 420. This path may never attain a stable state if the values of both the SEL_A 424 and SEL_B 425 signals are both 1 at the same time. There is also a loop from the output of MUX A 420 to the input of MUX A 420 and there is a loop from the output of MUX B 421 to the input of MUX B 421.

However, any path which contains an edge triggered flip flop is not considered to be a loop because the data at the input is only transferred to the output when the clock edge makes a transition. Thus, the output of the flip flop stabilizes immediately after the transition of the clock. For example, referring to FIG. 16, the path from signal COUT 401 through register D 402, through signal BOUT 403, through register C 400 does not form a logic loop. Even if two different clocks were sent to register C 400 and register D 402 there would be no logic loop.

If a logic circuit 270 contains a logic loop then it is not possible for the signal values in the logic circuit to be evaluated because they will not stabilize. There are methods known in the state of the art for detecting logic loops. Any of these methods may be used to determine if such loops exist in the accelerator circuit subset. The detection of logic loops in the accelerator circuit subset 274 is done by the mapper 80 at compile time.

### Deadlock Prevention and Serialization of Evaluations

It is possible for deadlock to occur if a terminal node B has halted processing pending the arrival of terminal node state 390 from another terminal node ‘A’ and, simultaneously, terminal node A cannot provide the terminal node state 390 until terminal node B provides terminal node state 390 to another terminal node.

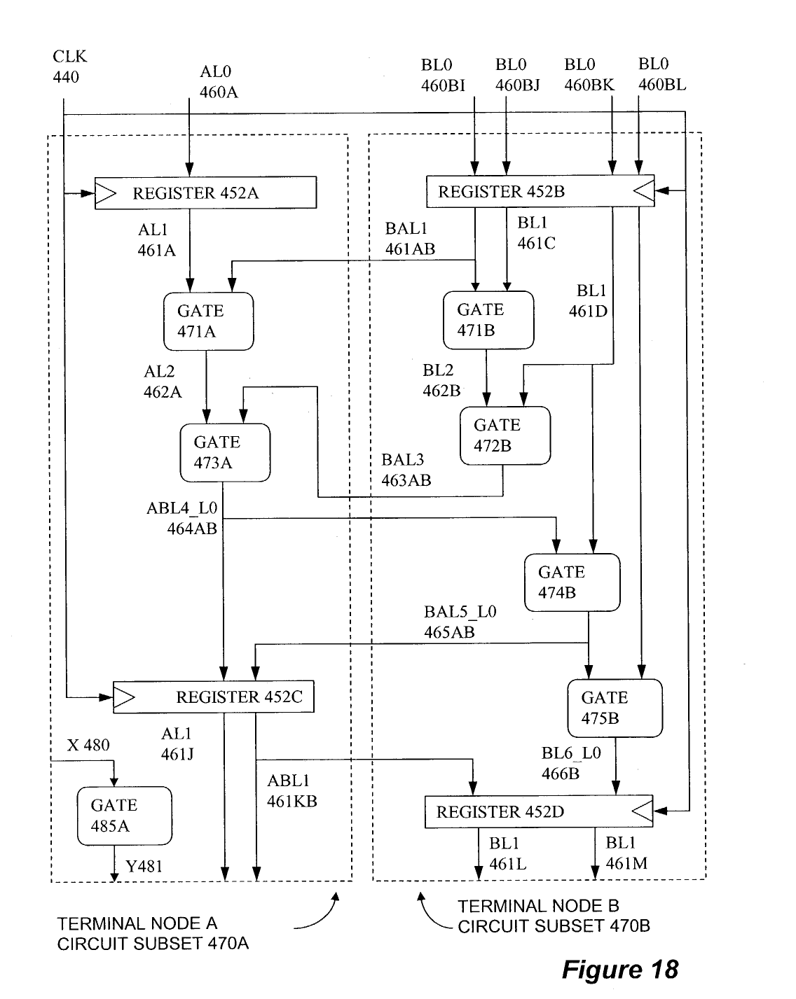

An example is illustrated in FIG. 18. In this example a terminal node A circuit subset 470A has been mapped onto a terminal node A and a terminal node B circuit subset 470B has been mapped onto a terminal node B. When the signal CLK 404 makes a low to high transition during a simulation a trigger command 383 is sent to both terminal node A and terminal node B. Suppose terminal node B elects to evaluate GATE 474B before GATE 472B. When terminal node A attempts to evaluate GATE 473A it will halt processing pending the arrival of the new value of signal BAL3 463AB. Similarly, terminal node B will halt the evaluation of GATE 474B pending the arrival of the new value of signal ABL4_LO 464AB. At this point a deadlock occurs because neither terminal node A or terminal node B will be able to complete their evaluations of updated signal values. In the present invention such deadlocks are avoided by properly ordering the evaluation of the new signal values in terminal node A circuit subset 470A and terminal node B circuit subset 470B. In the preferred embodiment the mapper 80 avoids the possibility of deadlock by passing information to each terminal node 54 about the order in which logic signals should be evaluated.

First, the mapper 80 identifies the simulation events which will require updates to the signal values in the accelerator logic circuit subset 274. These may be changes to input values in the circuit, clock transitions, input from the simulation user 41 and any other event which may cause the terminal node state 390 to require updates. For each of these events the mapper 80 determines the trigger commands 383 which will be sent to each terminal node 54 to initiate the processing required to update the terminal node state 390. The mapper 80 further identifies the portions of the accelerator logic circuit subset 274 which will be updated by each terminal node 54 in response to the trigger commands 383 which that terminal node 54 may receive. The set of all portions of the accelerator logic circuit subset 274 which are updated by all terminal nodes 54 in response to the trigger command 383 which it receives is referred to as the trigger circuit subset for that trigger command 383. Note that the trigger circuit subset includes portions of the circuit subsets of a plurality of terminal nodes 54. Also note that the loop detection and logic loop elimination done by the mapper 80 insures that there are no loops within a trigger circuit subset.

The mapper 80 then identifies all inputs to the trigger circuit subset which may change value when a particular trigger command 383. These are referred to as trigger inputs. These signals are assigned a level of 0. Note that there may be many signals which are assigned a level of 0. Also note that an input to a clocked flip flop is an input to the trigger circuit subset associated with a transition in the clock input to the flip flop.

For example, referring to FIG. 18, suppose that the terminal node A circuit subset 470A mapped onto terminal node A and the terminal node B circuit subset 470B mapped onto terminal node B represent the entire logic circuit to be simulated. Then, the trigger circuit subset for the trigger command 383 which is sent when a rising edge occurs on CLK 440 would be comprised of all circuit elements except GATE 485A. The following signals are assigned a level of 0 because they are inputs to the trigger circuit subset are: BL0 460B1, BL0 460BJ, BL0 460BK, BLO 460BL, AL0 460A. All of the inputs to trigger circuit subset in the example circuit are inputs to clocked registers. The signals which are assigned a level of 0 because they are inputs to the trigger circuit subset are: BL0 460B1, BL0 460BJ, BL0 460BK, BL0 460BL, AL0 460A, BAL5_L0 465AB, ABL4_L0 646AB, BL6_L0 466B.

Once the signals which are level 0 signals are identified the mapper 80 identifies all combinatorial elements which can be evaluated with only signals with a level number of 0. In other words, the combinatorial elements whose inputs have been assigned a level number of 0. The output of these combinatorial elements are given a level number of 1. This process is repeated with each signal which can be evaluated with only signals with a level number of n or less being given a level number of n+1 until all signals within the trigger circuit subset have been assigned a value.

FIG. 18 illustrates this process when the trigger command 383 represents a positive transition for the signal CLK 440. The flip flop inputs are level 0 signals. The outputs of the flip flops can be evaluated using only the inputs and are therefore level 1 signals. Thus, AL1, BAL1 461AB, BL1 461C, BL1 461L, BL1 461M, AL1 461J, and ABL1 461KB are assigned a level of 1. Gate 471B and gate 471A can be evaluated using only signals AL1 461A, BAL1 461AB, and BL1 461C which all have a level of 1. Therefore, the output of these gates (signals BL2 462B and AL2 462A) will be assigned a level of 2. Gate 472B has an input, BL1 461C, assigned a logic level of 1 and an input, BL2 462B, assigned a level of 2. Therefore, its output has a level of 3. This process is continued until all signals in the trigger circuit subset have been assigned a level number.

Note that the input to a clocked circuit element can be assigned two level numbers when considering the trigger circuit subset associated with the clock input to the clocked circuit element. The first level number is 0 because it is an input to a clocked circuit element. The second level number is the level number assigned from examining the level numbers assigned to the input signals of the circuit element which drives the signal. In the example shown in FIG. 18 signal ABL4_L0 464AB is such a signal. Because it is an input to a register 452C it has a level of 0. Because it requires signals which have a level of 3 for evaluation signal ABL4_L0 464AB also has a level of 4. The initial level number of 0 is only used to evaluate inputs to the loop segment. Otherwise, the higher value of 4 must be used.

During a simulation the following restriction on the order in which new signal values are evaluated must be observed:

1) An input to a trigger circuit subset, including clocked elements such as a flip flop or register, must be used before it is updated. The mapper 80 identifies all such signals in the logic circuit which will be updated during the processing of a trigger command 383.

2) For each terminal node 54 the mapper 80 identifies the portion of the trigger circuit subset which has been mapped onto that terminal node 54. This is referred to as the terminal node trigger circuit subset. The mapper 80 identifies all input signals and output signals of each terminal node trigger circuit subset. Within a terminal node 54 the new value of any terminal node trigger circuit subset output which has been assigned a level of less than n must be evaluated before the new value of any terminal node trigger circuit subset input with a level of n is used. Further, the new value of any terminal node trigger circuit subset output which has been assigned a level of less than n must be transferred from the producing terminal node 54 to the consuming terminal node 54 before the new value of any terminal node trigger circuit subset input with a level of n is used.

3) For any given path through the combinatorial logic in the circuit subset the new signal values of inputs to a combinatorial element be evaluated before the new value of the output of the combinatorial element is evaluated.

There are methods known in the state of the art to maintain this ordering between the evaluation and use of new signal values within a terminal node 54. One example is to construct a dependency graph of all computations known. From the dependency graph the mapper 80 can create a list of signals in the order which they are to be evaluated. Another example involves a terminal node 54 based on a programmable processor. When the mapper 80 constructs the instruction sequence for the processor in the terminal node 54 the instructions are ordered so that the simulation operations will be performed in the order required. The mapper 80 includes the information regarding ordering in the download database 76.

The ordering of updates to terminal node state 390 between terminal nodes 54 may be maintained using semaphores 392 and expected semaphore values 393. If a terminal node 54 must postpone the transfer of a signal value then the terminal node 54 may compare the value of a semaphore 392 with an expected semaphore value 392 and postpone transferring the new signal value until the value of the semaphore 392 matches the expected semaphore value 392. By postponing the transfer until the semaphore has the expected value ordering is maintained. If use of a signal value should be made only after it has been transferred from another tenninal node 54 then the value of the semaphore 392 associated with that signal is compared to the associated expected semaphore value 393. If the semaphore value is not the expected semaphore value 393 the semaphore 392 is continually checked until the semaphore 392 has the expected semaphore value 393. Then the signal value can be used.

### Semaphore Usage: Optimizations

There are several methods of semaphore use which the mapper 80 may employ to increase the efficiency of the accelerator 51. In discussing these optimization signals values or other data values which will be sent from a terminal node 54 via data commands 384 are referred to as inter-terminal outputs and signals values which will be received by a terminal node 54 via data commands 384 are referred to as inter-terminal inputs.

In one optimization the mapper 80 may associate multiple inter-terminal inputs with a single semaphore 392. For example, suppose a plurality of signals which have been assigned a level of 1 is sent from a terminal node X to a terminal node Y. The mapper 80 may indicate, via the download database 76, that all of these signals be transferred from terminal node X to a terminal node Y and then that a single semaphore 392 be updated. Before using any of these signals terminal Y would only need to check the single semaphore 392 against the expected semaphore value 393. In addition, the use of one semaphore 392, rather than a plurality of semaphores 392, decreases the traffic on the simulation network 52.

In another optimization the mapper 80 instructs, via the download database 76, that the evaluations required to determine the new values of inter-terminal outputs be performed as soon as possible and that these inter-terminal outputs be transferred to the consuming terminal nodes 54C as soon as possible. This reduces the possibility that a terminal node 54 will suspend processing to wait for a semaphore value to be the expected value.

In another optimization the mapper 80 identifies inter-terminal inputs and their associated semaphores 392. It instructs, via the download database 76, that any evaluations done in a terminal node 54 which require an updated inter-terminal input value be performed as late as possible.

In another optimization the mapper 80 attempts to place the producing and consuming terminal nodes 54 of data commands 384 used to communicate terminal node state 390 at locations on the simulation network 52 which have the shortest routing path between them.

In another optimization the mapper 80 duplicates circuitry which is within the logic circuit. Each copy of the circuitry is mapped onto different terminal nodes 54. This may reduce the number of inter-terminal inputs. For example, in FIG. 18 Gate 474B is currently mapped into the circuit subset for terminal node B 470B. The sequence of processing which is required is: send BAL3 463AB to terminal node A, evaluate GATE 473A, send ABL4_L0 646AB to terminal node B, evaluate GATE 474B, send BAL5_L0 465AB to terminal node A. However, suppose gate 471B, GATE 472B, and GATE 474B are duplicated and placed in the circuit subset of terminal node A. Then, at the start of the processing of the trigger command 383 terminal node B can send the new values of signals BAL1 461AB, BL1 461C, and BL1 461D to terminal node A. These transfers can take place together and do not require any input from terminal node A. Terminal node A evaluates the duplicated gates and only sends one signal (ABL4_L0 464AB) back to terminal node B. This will speed the processing of the trigger signal by reducing the coordination between terminal node A and terminal node B. In another variation, the portions of register 452B which drive signals BAL1 461AB, BL1 461C, and BL1 461D can be duplicated in the circuit subset of terminal node A. The inputs to these register bits then need to be transferred to both terminal node A and terminal node B. However, these transfers take place in the latter stages of processing the trigger command 383 associated with the rising edge of CLK 440. Therefore, it is less likely that processing will be delayed.

### Terminal Node: A Logic Evaluation Processor (LEP)

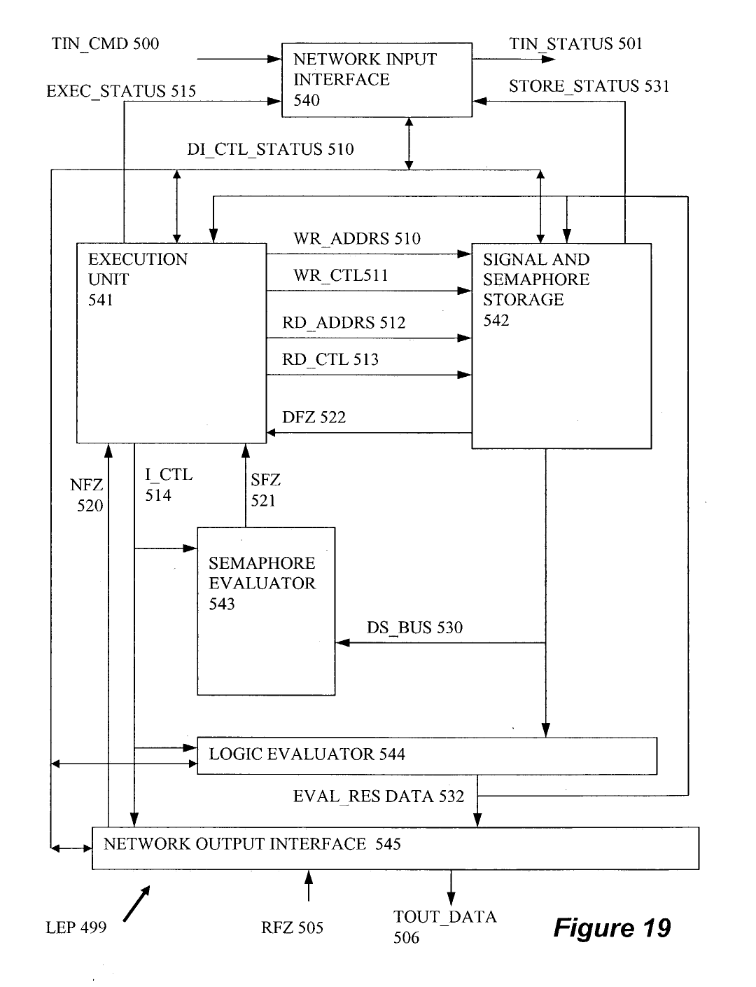

FIG. 19 illustrates a preferred embodiment of a terminal node referred to as a logic evaluation processor or LEP 499. The logic evaluation processor is comprised of the following modules:

1) The network input interface 540. All input to the LEP 499 passes through this module.

2) An execution unit 541 which directs the processing associated with trigger commands 383.

2) Signal and semaphore storage 542. This module stores the current values of signals, semaphores 392 and other terminal node state 390 which is used during a simulation. The term logic_data is used to refer to this data.

3) A logic evaluator 544. This module performs operations on a plurality of logic_data and information sent from the execution unit 541.

4) A semaphore evaluator 543 which accepts as input a plurality of semaphore values 392 and expected semaphore values 393 and produces a plurality of output signals which indicate the whether the actual semaphore values 392 and the expected semaphore values 393 match.

6) A network output interface 545. All output from the logic evaluation processor is assembled by the network output interface 545 and presented on tout_data 506.

All input to the terminal node 54 is in the form of download commands 381, initialization commands 382, trigger commands 383, and data commands 384, which are presented to the network input interface 540 on TIN_CMD 500. The network input interface 540 has internal storage which can store a plurality of download commands 381, initialization commands 382, trigger commands 383, and data commands 384. If the internal storage for download commands 381, initialization commands 382 or data commands 384 is exhausted then the network input interface 540 indicates this to any attached routing nodes 53 via TIN_STATUS 501. It is then the responsibility of the attached routing nodes 53 to refrain from sending additional download commands 381, initialization commands 382, or data commands 384. If the internal storage for trigger commands 383 is exhausted then the network input interface 540 indicates this to any attached routing nodes 53 via TIN_STATUS 501. This is considered to be an error. The source of the trigger commands 383 is responsible for prevented over-subscription of the storage used for trigger commands 383.

When a download command 381 or initialization command 382 arrives the network input interface 540 examines the command and determines which of the other modules (execution unit 541, signals and semaphore storage 542, semaphore evaluator 543, logic evaluator 544, or network output interface 545) require the information contained in the command. These are referred to as the di target modules. The network input interface 540 reformats the command to create dif_data. Each module returns di_status, via di_ctl_status 510, to the network input interface 540 to indicate whether it can accept dif_data via DI_CTL_STATUS 510. If the di_status returned from any di target module indicates that it cannot accept di data then the network input interface 540 pauses the transfer of dif-data over DI_CTL_STATUS 510. When the di target modules indicates that they can accept dif_data the network input interface 540 transfers the dif_data to the di target modules via DI_CTL_STATUS 510. The di target modules then update their internal data structures. In addition, the network input interface 540 may use the dif_data to initialize its own data structures.

When a data command 384 arrives at the network input interface 540 the contents are reformatted, as needed to produce d_data. If the store_status 531 which is sent from signal and semaphore storage 562 to the network input interface 540 indicates that signal and semaphore storage 542 cannot accept d_data then the network input interface 540 pauses the transfer of the d_data until it can be accepted. Then the network input interface 540 forwards the d_data, via di_ctl_status 510, to signal and semaphore storage 542. The module signal and semaphore storage 542 updates the values of the terminal node state 390 specified in the data command 384 with the values specified in the data command 384. In addition, signal and semaphore storage 542 indicates to the execution unit 541, via DFZ 522, that an update is taking place. The execution unit 541 suspends its activities, if necessary, to allow the update to occur.

When a trigger command 383 arrives at the network input interface 540 the contents are reformatted to produce t_data. If the exec_status 515 which is sent from the execution unit 541 to the network input interface 540 indicates that the execution unit 541 is unable to process new t_data then the network input interface 540 pauses the transfer of the t_data. When the exec_status 515 indicates that the trigger command 383 can be processed the t-data is forwarded to the execution unit 541, via di_ctl_status 510.

When t_data is received by the execution unit 541 it is examined to determine what processing should be performed. The execution unit 541 manipulates the I_CTL 514, RD_ADDRS 512, RD_CTL 513, WR_ADDRS 510, and WR_CTL 513 interfaces to perform this processing. The execution unit 541 communicates with signal and sempahore storage 542 using RD_ADDRS 512 and RD_CTL 513 to read a plurality of terminal node state 390 from signal and semaphore storage 542. The plurality of terminal node state 390 is forwarded to the semaphore evaluator 543 and the logic evaluator 544, via the DS_BUS 530. The execution unit 541 also sends instr_ctl, via I_CTL 514, to the semaphore evaluator 543, logic evaluator 544 and network output interface 545.

The logic evaluator 544 examines I_CTL 514 to determine what activities to perform. The logic evaluator 544 may store incoming terminal node state 390 or internally generated data values in internal data structures. Data manipulations may be performed using incoming terminal node state 390 and/or data stored in internal data structures. The result of the data manipulations, referred to as eval_res data 532 and is sent to signal and semaphore and storage 542. The execution unit 541 communicates with signal and sempahore storage 542 using WR_ADDRS 510 and WR_CTL 513 to store selected portions of eval_res data within signal and sempahore storage 542.

The eval_res data 532 is also presented to the network output interface 545. The instr_ctl indicates, via I_CTL 514, whether the eval-res data 532 should be forwarded to a routing node 53 which is attached to the LEP 499. The instr_ctl, via ICTL 514, also specifies additional terminal node state 390 to be forwarded, and how to format the data into packets 289. The network output interface 545 presents NFZ 520, which indicates whether new eval_res data 532 can be accepted, to the execution unit 541. If NFZ 520 indicates that eval_res data 532 cannot be accepted then the execution unit 541 pauses processing until NFZ 520 indicates that eval_res data 532 can be accepted. The network output interface 545 reformats the eval_res data 532 and instr_ctl data (on I_CTL 514) to produce information to be to be forwarded to an attached routing node 53 via TOUT_DATA. If the routing node 53 indicates, via RFZ 505, that data cannot be accepted then the network output interface 545 pauses its transfer.

The semaphore evaluator 543 contains a plurality of stored expected semaphore values and a plurality of comparators. The operations which are performed by semaphore evaluator 543 are determined by instr_ctl, which is sent from the execution unit 541 via I_CTL 514. When indicated by inst_ctl a subset of the stored expected semaphore values 393 are loaded with data from either I_CTL 514 or DS_BUS 530. When indicated by inst_ctl the values of semaphores 392, sent via DS_BUS 530, are compared with associated expected semaphore values or with a semaphore value sent via I_CTL 514. Semaphore evaluator 543 indicates the results of this evaluation via SFZ 521 to the execution unit 541. If SFZ 521 indicates that the values of the semaphores 392 do not match the expected semaphore values 393 then the execution unit 541 pauses processing. In addition, the execution unit 541 uses RD_ADDRS 512 and RD_CTL 513 to continually read the semaphore values 392 from signal and semaphore storage 542. This continues until SFZ 521 indicates that the values of the semaphores 392 match the expected semaphore values 393. In addition, the semaphore evaluator 543 contains internal storage for expected semaphore values.

There are many possible embodiments of each module within the LEP 499. Method counterparts to each of these embodiments are also provided. Other system, methods, features and advantages of the invention will be or will become apparent to one with skill in the art upon examination of the following figures and detailed description. It is intended that all such additional system, methods, features and advantages be included within this description, be with the scope of the invention, and be protected by the accompanying claims.

### Terminal Node: A Memory Storage Processor

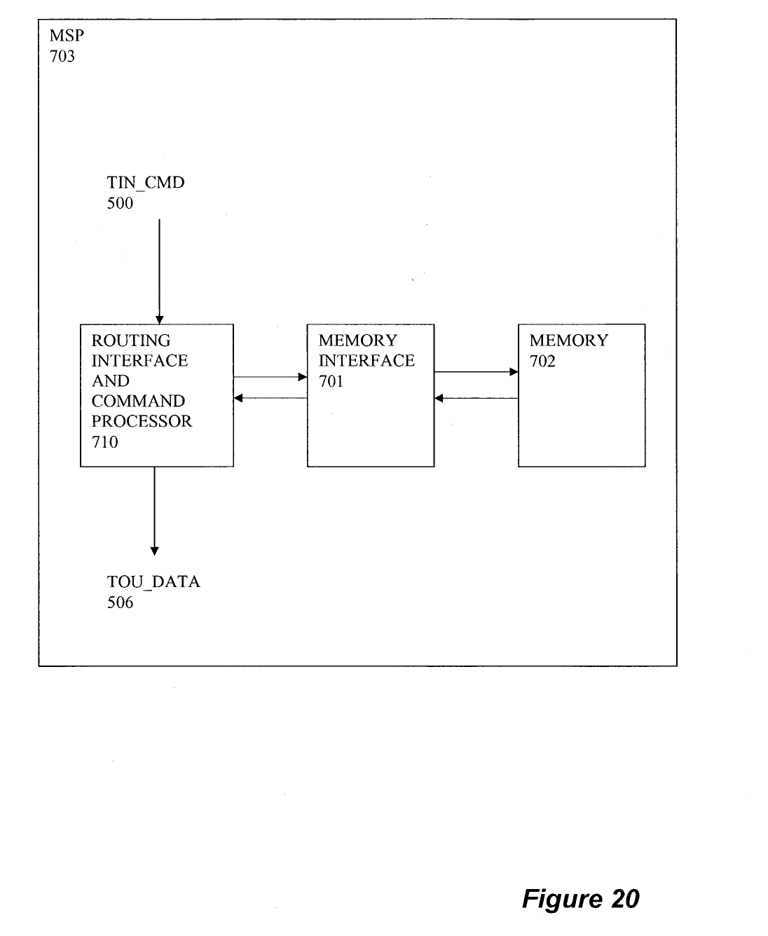

Another preferred embodiment of a terminal node 54 is a memory storage processor (MSP 703), illustrated in FIG. 20. The MSP 703 is comprised of a routing interface and command processor 710 (referred to as RICP 710), a memory interface 701 and a memory 702.

At compile time the mapper 80 determines which terminal node state 390 will be stored in the memory within the MSP 703. This may include signal values, semaphore values 392, expected semaphore values 393, and any other data values used during simulation. The mapper 80 determines which trigger commands 383 may update or use the terminal node state 390 which is stored in the memory during their processing. The mapper 80 includes, in the download database 76, the information required by other terminal nodes 54 to send trigger commands 383 or data commands 384 to the MSP 703 to obtain or update the appropriate data. The mapper 80 also constructs the information required by the routing interface and command processor to handle these commands.

When a download command 381 or initialization command 382 arrives at the MSP 703 the RICP 710 determines which data structures should be updated and the new values to be used for the updates. If they are data structures internal to the RICP 710 then the RICP 710 performs the updates. If the data structures are within the memory then the RICP 710 uses the memory interface 701 to write the new values to the specified locations in memory 702.

When a trigger command 383 or data command 384 arrives at the MSP 703 the RICP 710 updates the appropriate terminal node state 390 within the MSP. This includes any updates to semaphores 392 or expected semaphore values 393. It also includes checking the value of semaphores 392 against associated expected semaphore values 393. The RICP 710 may also construct data commands 384 and/or trigger commands 383 to be sent to other terminal nodes 54. These data commands 384 and/or trigger commands 383 are formatted within packets 289 and sent to the routing node 53 to which the MSP 703 is attached.

The use of semaphores allows for efficient update and use data which corresponds to large memory blocks within the accelerator circuit subset 274.

### Terminal Node: I/O Interface Processor

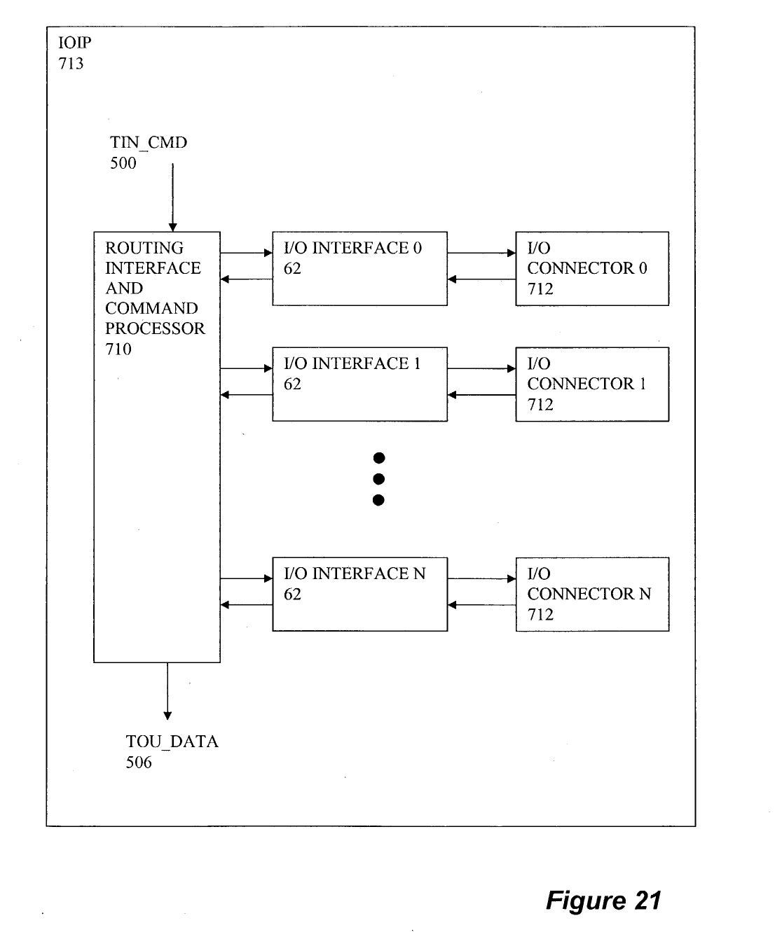

Another preferred embodiment of a terminal node 54 is I/O interface processor (IOIP 713), illustrated in FIG. 21. The IOIP 713 is comprised of a routing interface and command processor (referred to as RICP 710), a plurality of I/O interfaces 62, and a plurality of I/O connectors.

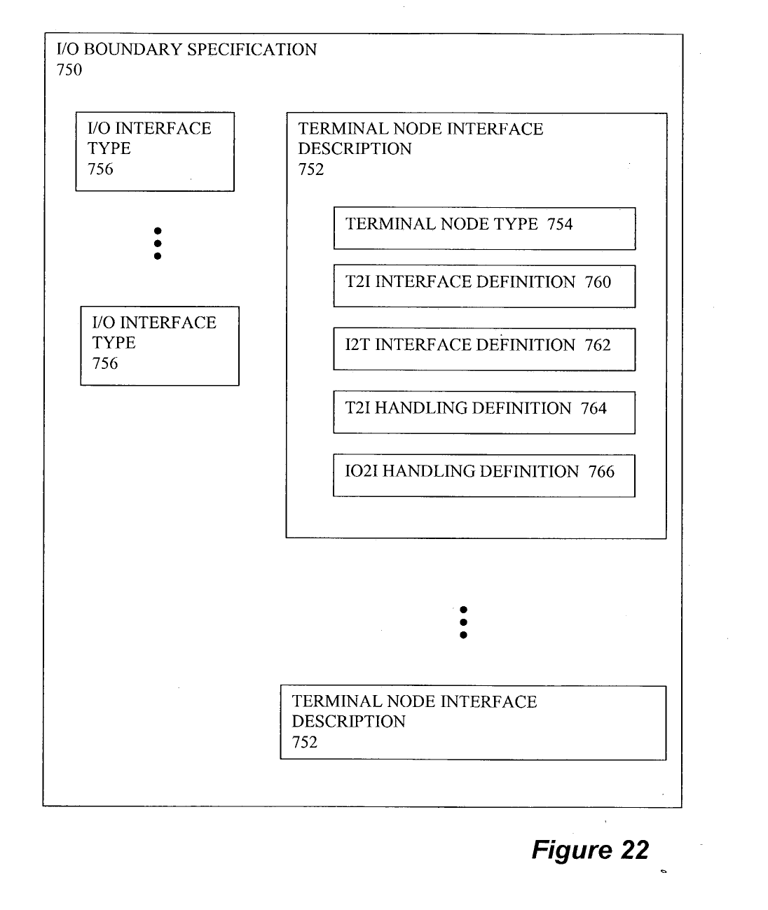

As illustrated in FIG. 22, the boundary between the portion of the logic simulation which is mapped into an IOIP 713 and the remainder of the circuit is defined by an I/O boundary specification 750. The I/O boundary specification 750 is included in the logic circuit database 72. The I/O boundary specification 750 includes a plurality of I/O interface types 756. Each I/O interface type 756 specifies a type of I/O interface 62 which is supported within the IOIP 713. Note that a single IOIP 713 may support a plurality of types of I/O interfaces 62. The I/O boundary specification 750 further includes a plurality of terminal node interface descriptions 752. Each terminal node interface description 752 further includes a terminal node type 754, a T2I interface definition 760, an I2T interface definition 762, a T2I handling definition 764, and an 102I handling definition 766.

A T2I interface definition 760 describes the T2I commands and T2I packets used to transfer information from the terminal nodes 54 which are of the type specified by the terminal node type 754 to the IOIP 713. For example, the T2I interface definition 760 for a terminal node type 754 which represents an ‘LEP 499’ may be a set of interface signals and information which indicates that any change in value of an interface signal be sent as a data command 384 from the LEP 499 to the IOIP 713. Alternatively, the T2I interface definition 760 for a terminal node type 754 which is ‘LEP 499’may specify that a set of signal values be transferred when a particular signal (e.g. write_enable) changes value. In another example, the T2I interface definition 760 may be for a terminal node type 754 which is ‘CPU_based’, where this type of terminal node 54 contains a programmable processor. In this case the T2I interface definition 760 may be a series of function calls and the conditions under which each function is called. In addition, the commands which should be sent to the IOIP 713 with each function call are specified. In this case the mapper 80 is responsible for generating the code for each function. These functions will be executed on the terminal node 54. Alternatively, the T2I interface definition 760 may be for a terminal node type 754 which is ‘CPU_based’ may specify only the commands which may be sent to the IOIP 713.

An I2T interface definition 762 describes the I2T commands and I2T packets used to transfer information from the IOIP 713 to the terminal nodes 54 which are of the type specified by the terminal node type 754. For example, the I2T interface definition 762 for a terminal node type 754 which is ‘EP 499’ may specify a set of interface signals and the data commands 384 and trigger commands 383 which are used to communicate changes in the value of these signals when they are detected by teh IOIP 713. In addition, the conditions under which changes in value should be communicated are specified.

For both the I2T interface definition 762 and T2I interface definitions 760 a wide variety of interface definitions are possible. The example implementations included here are illustrative. Many other implementations are possible so this description should not be taken as limiting.

A T2I handling definition 764 specifies how the IOIP 713 is to handle data commands 384 and trigger commands 383 sent from each terminal node 54. For example, if the IOIP 713 contains a programmable processor then the program for the processor is supplied. If the IOIP 713 contains a field programmable gate array (FPGA) then the download database 76 for the FPGA is included. If the IOIP 713 contains configuration registers then the values of the configurations registers are included. The handling of each command may include updates of the terminal node state 390 held within the IOIP 713. The handling of each command may also describe transfers to be made over the I/O interface 62 and transfers of packet 289 over the simulation network 52.

An IO2I handling definition 766 specifies how the IOIP 713 is to handle I/O transfers which are presented over the I/O interface 62. Such I/O transfers may be changes in values on single lines, or it may be a complex transaction. When an I/O transfer is detected the handling may include updates of the terminal node state 390 held within the IOP 713. The handling of each I/O transfer may also include the initiating additional transfers over the I/O interface 62. The handling of each I/O transfer may also include transfers of packets 289 to be made over the simulation network 52.

At compile time the mapper 80 determines which portion of the logic circuit will be stored in each IOIP 713 within the accelerator 51. This information may be specified explicitly in the logic partition database 71 or the mapper 80 may determine that the interfaces to a particular portion of the logic circuit match the interfaces described in an I/O boundary specification 750. Further, the mapper 80 determines which circuitry will interface with each IOIP 713 and which terminal nodes 54 contain this circuitry in their circuit subset (each is referred to as an I/O terminal node).

For each terminal node 54 the mapper 80 specifics the information required to determine when the terminal node should send information to each IOIP 713. Further, the mapper 80 supplies the information required by each IOIP 713 to construct the appropriate T2I commands and encapsulate them in the appropriate T2l packets for transfer over the simulation network 52. The mapper 80 also specifies the processing to be done by each IOIP 713 in response to trigger packets specified in the I2T interface definition 762. The form of this information is dependent on particular implementation of the IOIP 713 . All of this information is included in the download database 76.

For each IOIP 713 the mapper 80 translates the IO2I handling definition 766 and the T2I handling definition 764 into a form which is understood by the IOIP 713. This information is also included in the download database 76. For example, if the IOIP 713 contains a programmable processor then the program for the processor is supplied. If the IOIP 713 contains a field programmable gate array (FPGA) then the download database 76 for the FPGA is included. If the IOIP 713 contains configuration registers then the values of the configurations registers are included.

When a download or initialization command 382 arrives at the IOIP 713 the RICP 710 determines which data structures should be updated and the new values to be used for the updates. If they are data structures internal to the RICP 710 then the RICP 710 performs the updates. If the data structures are within an I/O interface 62 then the RICP 710 transfers the appropriate information to the I/O interface 62 where the updates occur.

When a trigger command 383 arrives at the IOIP 713 the RICP 710 determines what processing should be performed, as specified in the T2I handling definition 764, and completes the processing.

### Terminal Node: I/O Interface Processor, CRT IOIP

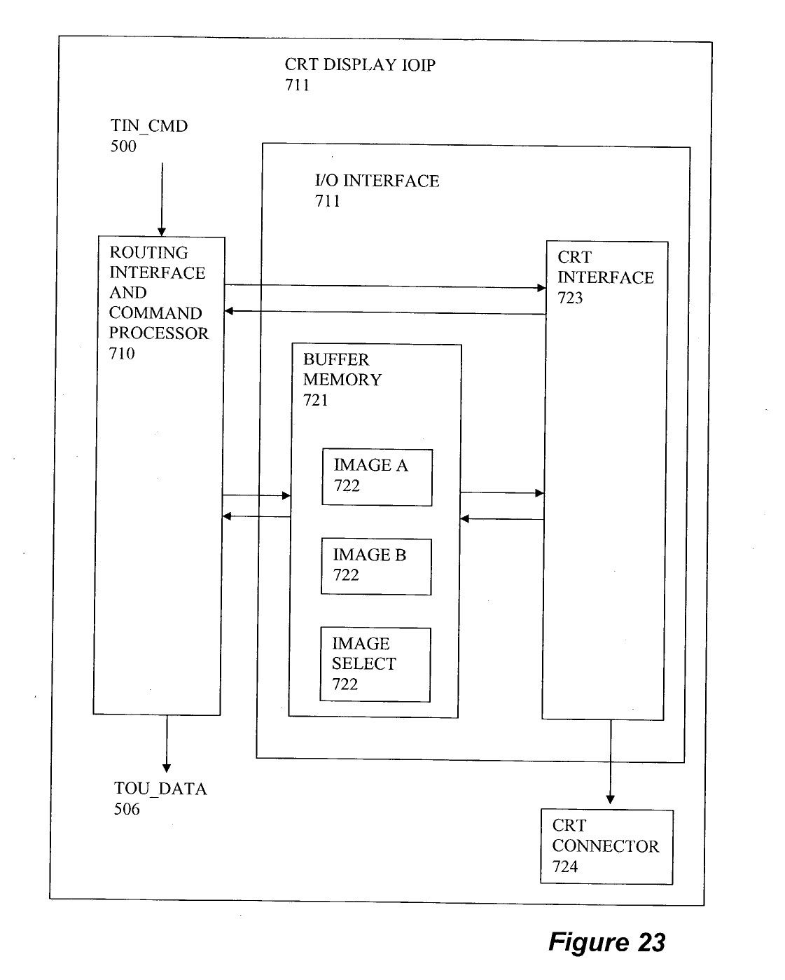

FIG. 23 illustrates an embodiment of a crt display IOIP 713 which is used to drive a cathode ray terminal (CRT). The crt display IOIP 713 is further comprised of a routing interface and command processor (RICP 710), which is connected to a single routing node 53, a crt interface which controls a crt display, a crt connector which is used to make a physical connection to a crt display, and a buffer memory. The buffer memory stores an image A, which is a series of data values which correspond to the values of pixels which should be displayed on the crt, an image B, which is also a series of data values which correspond to the values of pixels which should be displayed on the crt, and an image select which indicates whether image A or image B should be displayed.

When a download or initialization command 382 is received the RICP 710 passes the information in the command to the crt interface, which updates its internal state. This information includes the type of display being driven and the organization of data in the buffer memory. The RICP 710 also uses the information to update its own internal data structures with a description of the organization of data in the buffer memory.

When a data command 384 arrives the RICP 710 determines whether the command indicates that an update should be performed to the image select, or to locations within image A or image B. If the image select is to be updated then the RICP 710 extracts the new value from the command and loads it into the image select. If an update is to be done to image A or image B then the RICP 710 determines which pixels within image A or image B should be updated and also extracts the new values for those pixels. The RICP 710 then converts the pixel addresses to memory addresses by referring to the description of the organization of data in the buffer memory which is stored in its own internal database. The RICP 710 then updates these memory locations with the new pixel values.

The crt interface determines whether the image select refers to image A or image B at the start of each new frame. The ert then retrieves the data from the buffer identified by the image select, formats the data for the crt and transfers the data over the crt connector.

### Terminal Node: I/O Interface Processor, Network IOIP

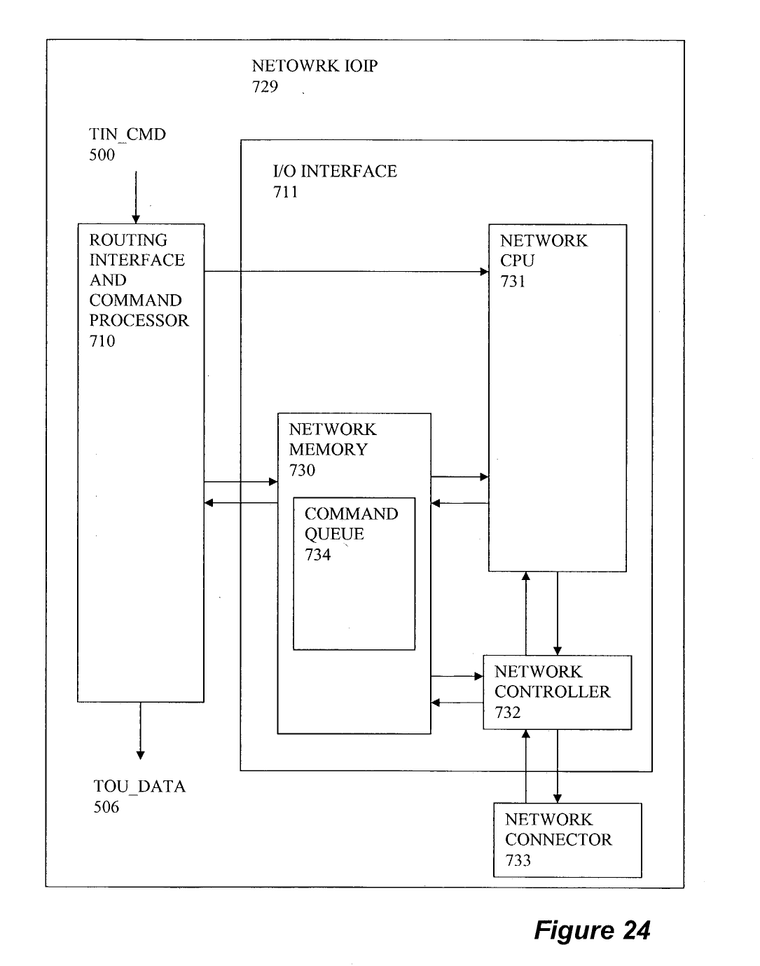

FIG. 24 illustrates an embodiment of a network IOIP 729 which is used to interface to a network device. The network IOIP 729 is further comprised of a routing interface and command processor (RICP 710), which is connected to a single routing node 53, a network memory 730 which is used to temporarily store network packets and other terminal node state 390, a network CPU 731, a network controller 732, and a network connector. 733 The T2I interface definition 760 is based on a set of subroutines which are executed by the network CPU 731. These subroutines may be used to control the network controller 732, or to update or transfer terminal node state 390. A subset of these subroutines correspond to the entry points in a driver for the network controller 732 which would typically be found in a workstation or personal computer. The T2I interface definition 760 identifies a command for each subroutine. These commands contain all of the inputs to the function call executed by the network CPU 731. Also contained in each command is a token to be returned when the function call has completed. The commands may be download commands 381, initialization commands 382, trigger commands 383, or data commands 384.

The I2T interface definition 762 specifies a command to be used to return the results from each command in the T2I interface definition 760. The I2T interface definition 762 also specifies a command which can be used to return inputs which arrive from the network controller 732. Examples include interrupts generated by the network controller 732 and data which arrives via the network connector.

The T21 handling definition 764 contains a set of routines which handle each command specified in the T2I interface definition 760. The IO2I handling definition 766 contains a set of routines which are used to handle inputs which arrive from the network controller 732. Examples include interrupts generated by the network controller 732 and network packets which arrive via the network connector. These commands may be data commands 384 or trigger commands 383. The functions defined may be based on a driver typically run on the CPU of a workstation or PC. Note that the interface presented to the terminal node may represent a different network controller 732 than the network controller 732 within the network IOIP 729. The functions executed on the network CPU 731 convert the T21 interface to the interface of the network controller 732 device on the network IOIP 729.

The download information constructed by the mapper 80 includes the program to be executed by the network CPU 731 and instructions for transferring that program to the CPU. The initialization information is one or more initialization commands 382 which are used to start execution of the network CPU 731.

When a download command 381 is received the RICP 710 parses the download command 381 to obtain an address within network memory 730 and the length of the data included. The RICP 710 downloads the data into the specified location within network memory 730. When an initialization command 382 is received the RITCP 710 notifies the network CPU 731 to begin execution.

When a data command 384 arrives at the network IOIP 713 the RICP 710 places the data command 384 in a command queue 734 which is stored in network memory 730. The CPU continually polls this command queue 734. When a command arrives the network CPU 731 parses the command to determine which subroutine as specified in the T2I handling definition 764 should be executed. It also determines the where the response to the subroutine is to be sent and which command, defined in the I2T interface definition 762 should be used to sent the response. The network CPU 731 then executes the corresponding subroutine, constructs the response using the appropriate command specified by the T2I handling definition 764, encapsulates the command within a packet and places the packet in a queue located in network memory 730. The RICP 710 polls this queue. When a complete packet is available then it is passed to the attached routing node 53.

When the network CPU 731 receives input from the network controller 732 it executes the corresponding function specified in the IO2I handling definition 766. During the course of execution it may construct data commands 384 or trigger commands 383 to be sent to other portions of the accelerator 51. These are placed in queues in network memory 730 and are forwarded by the RICP 710.

The execution of the program by the network CPU 731 allows the data rate supported by the accelerator 51 to be matched to the data rate supported by the network controller 732.

### Terminal Nodes: User Programmable

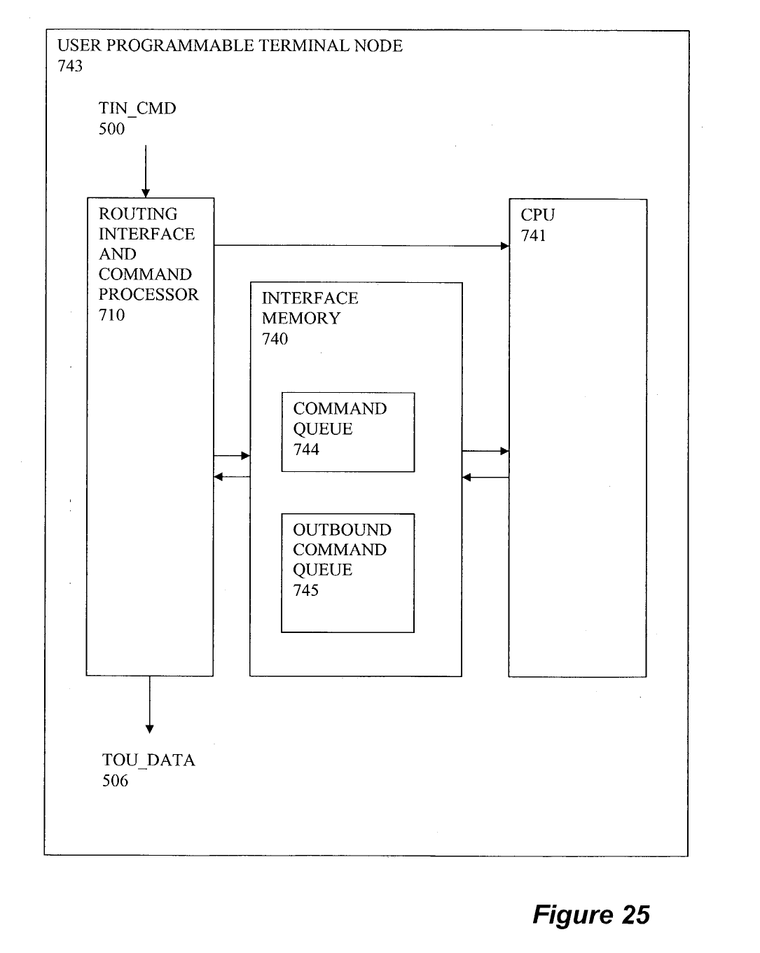

FIG. 25 illustrates an embodiment of a user programmable terminal node (UPTN 743). The UPTN 743 is further comprised of a routing interface and command processor (RICP 710), which is connected to a single routing node 53, a CPU 741, and an interface memory 740 which is used to temporarily store simulation network packets, other terminal node state 390, and a program to be executed by the CPU 741.

During simulation the CPU 741 executes subroutines to perform the processing required to update and maintain the terminal node state 390 stored in the UPTN 743. A T2I interface definition 760 for the UPTN 743 is based on the subroutines executed by CPU 741 and is provided by the user in the logic circuit database 72. The T2I interface definition 760 identifies a command for each subroutine. These commands contain all of the inputs to the function call executed by the network CPU 731. Also contained in each command is a token to be returned when the function call has completed. The commands may be download commands 381, initialization commands 382, trigger commands 383, or data commands 384.

The mapper 80 further specifies the conditions within the logic circuit under which each command may be sent. The mapper 80 provides the other terminal nodes 54 within the accelerator 51 with the information required to detect these conditions and to construct the commands specified in the T2I interface definition 760.

An I2T interface definition 762 specifies a set of commands used to return the results from the UPTN 743. These commands may be specified as a set of signal changes or as a set of function calls. In addition, the I2T interface definition 762 specifies commands which the UPTN 743 should construct and send, via packets 289, to other terminal nodes and the conditions under which these commands should be constructed. The conditions are specified by values of terminal node state 390.

The download information constructed by the mapper 80 includes the program to be executed by the CPU 741 and instructions for transferring that program to the interface memory. The initialization information is a single command which is used to start execution of the CPU 741.

When a download command 384 is received the RICP 710 parses the download command 384 to obtain an address within interface memory 740 and the length of the data included in the download command 384. The RICP 710 downloads the data into the specified location within memory 740. When an initialization command 382 is received the RICP 710 notifies the CPU 741 to being execution.

When a data command 384 or trigger command 383 arrives at the UPTN 743 the RICP 710 places the data command 384 or trigger command 383 in a command queue 744 which is stored in interface memory 740. The CPU 741 continually polls this command queue 744. When the CPU 741 determines that a command is in the command queue 744 the CPU 741 removes the command and parses the command to determine which subroutine as specified in the T2I handling definition 764 should be executed. The CPU 741 then executes the corresponding subroutine. In addition to updating terminal node state 390 within the UPTN 743 the CPU 741 may construct a packet 289 and place the packet 289 in a outbound command queue 745 located in interface memory 740. The RICP 710 polls this outbound command queue 745. When a complete packet 289 is available then it is passed to the attached routing node 53, via TOU_DATA 506.

This allows the user to implement large, well known amounts of computation in a faster media. For example, if a logic circuit contains a plurality of IEEE floating point processors then the simulation time may be reduced by performing this function with a CPU 741, instead of a logic circuit. This approach also allows the user to split simulations which normally run in one CPU system across multiple CPU systems.

### Terminal Nodes: Co-Simulation Control

For each co-simulator 60 the mapper 80 determines, at compile time, which portions of the logic circuit will reside in the co-simulator 60 and which will reside in the accelerator 51. This may be specified in the logic partition database 71 or the mapper 80 may determine the partition. Further, the mapper 80 determines which terminal nodes 54 interface with the co-simulator 60. This terminal node 54 may contain the co-simulator 60 or it may contain an interface which provides access to the co-simulator 60 (e.g. a network or bus interface).

Methods for implementing co-simulators are known in the state of the art. A user programmable terminal node 743 which can be used to implement these known methods. Multiple user programmable terminal nodes 743 can simultaneously support multiple co-simulations, allowing a larger, more flexible system to be constructed..

### Terminal Nodes: Summary

Several preferred embodiments of terminal nodes 54 have been presented. However, it is obvious to one versed in the state of the art that elements from multiple embodiments may also be combined to form new embodiments. In addition, the actions performed by the terminal nodes 54 may be partitioned across the terminal nodes 54 in any manner which is suitable for a specific implementation.

### Simulation Control and User Interface: A Preferred Embodiment

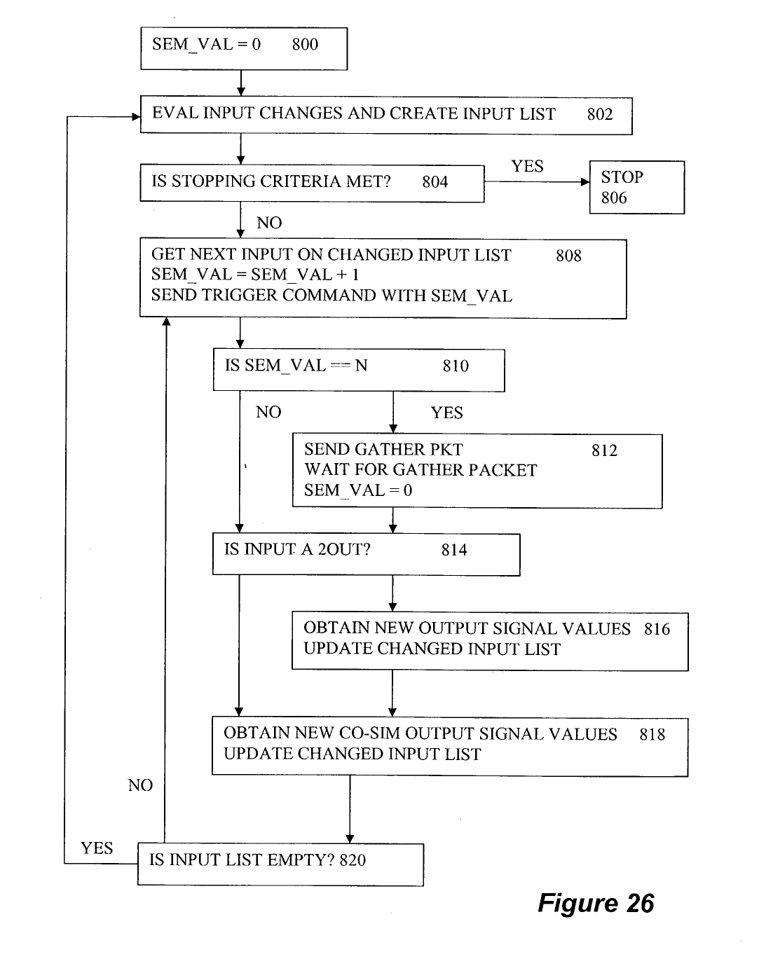

FIG. 26 illustrates the algorithm used to advance simulation time and to communicate with the accelerator 51 in a preferred embodiment of the simulation control and user interface 55 (referred to as SCUI). The SCUI 55 also acts as a co-simulation control terminal node and interfaces to one or more co-simulators 60.

The SCUI 55 assumes the following attributes of the embodiment of the accelerator 51 within the simulation system. First, that trigger commands 383 may be used to communicate changes in the values of signals which are inputs to the accelerator circuit subset 274. Further, that a expected semaphore value 393 is contained in each trigger command 383 and that the expected semaphore value 393 may be any value in the range [0, N]. Further, that each terminal node uses the expected semaphore value 393 as the expected semaphore value 393 for all terminal node state 390 which is updated during processing of the trigger commands 383 which contained the expected semaphore value 393. Further, the semaphore values 293 associated with all terminal node state 390 are initialized to 0 after download and initialization. Further, that the trigger commands 383 which are sent from SCUI 55 to the terminal nodes 54 remain ordered. Further, each terminal node 54 can accept a gather packet 281. In response to the gather packet 281 each terminal node completes the processing of all previous trigger commands 383 and then sends a gather packet 281 to an attached routing node 53. Further, the routing nodes 53 implement the embodiment of gather packets 281 described earlier (Routing Nodes and Simulation Network: Tree Embodiment) to ultimately produce a gather packet 281 which is sent to SCUI 55. This gather packet 281 indicates that all prior trigger commands 383 have been processed.

At compile time the mapper 80 examines every input signal to the accelerator circuit subset 274 and places each input signal into one of two classes: 2out, not2out. The mapper 80 examines the processing done when an input signal changes. If this processing can affect the value of an output signal from the accelerator circuit subset 274 then the input signal is classified as a ‘2out’ input signal. Otherwise, the input signal is classified as a ‘not2out’ input signal. This processing may be done when the mapper 80 identifies the trigger commands 383 which will be sent to the terminal nodes 54 when an input signal changes. These trigger commands 383 are used to communicate changes in value to the input signal to at least those terminal nodes 54 whose circuit subset 276 contains the signal.

At the start of a simulation the SCUI 55 performs all activities required when it receives a simulation start directive and simulation initialization directives from the simulation user 41.

After the download and initialization have been completed SCUI 55 begins to execute the algorithm illustrated in FIG. 35. At step 800 a variable sem_val, which represents the expected semaphore value 393, which is stored within SCUI 55 is initialized with a value of 0. In addition, all semaphore values 392 which stored in the terminal nodes 54, and associated with terminal node state 390 are set to a value of 0.

At each point in the simulation SCUI 55 determines whether any input to the accelerator circuit subset 274 has changed value. Changes may be observed in at least three ways. First, an output of the accelerator circuit subset 274 may also drive an input of the accelerator circuit subset 274. In this case, the SCUI 55 determines whether any such output signal of the accelerator circuit subset 274 has changed value. Second, an output from a co-simulator 60 may drive an input of the accelerator circuit subset 274. In this case, the SCUI 55 determines whether any such output signal of a co-simulator 60 circuit subset 276 has changed value. Third, the SCUI 55 examines the test input database 82 to see if any inputs have changed. If necessary the SCUI 55 advances simulation time until one or more input signal to the accelerator circuit subset 274 changes value. When any change in value to an input signal is detected a list, referred to as the changed input list, of all changes to input values is constructed by SCUI 55. The inputs whose values have changed may appear in any order on the changed input list.

After identifying changes in value to any of the inputs to the accelerator circuit subset 274 the SCUI 55 determines whether a stopping criteria has been met. The stopping criteria may be any criteria used in the art. Examples include stopping at a particular simulation time or stopping when a set of signals takes on a specific set of values. If the SCUI 55 requires the value of signals which are stored within the accelerator 51 then trigger commands 383 may be used to request the values of the signals. Alternatively, the values of such signal may be transferred by the terminal nodes 54 during the processing of other trigger commands 383. If the stopping criteria is met then processing proceeds to step 806 and the simulation is halted. Otherwise, processing proceeds to step 808.

In step 808 the next input on the changed input list is identified. This input will be referred to as the active input. Then, the SCUI 55 increments sem_val 800. The SCUI 55 then consults the data provided by the mapper 80 to construct a trigger command 383 which corresponds to a change in value on the active input. The data provided by the mapper 80 also indicates to which routing nodes 53 the trigger command 383 should be sent and how to assembly the address layer 288 of a packet destined for those nodes. In the case of a simulation network 52 and routing nodes 53 which support broadcast packets 280 this may be a single packet 289. If there are no broadcast packets 280 then the trigger command 383 is sent directly to a plurality of routing nodes 53. Contained within the trigger command 383 is an expected semaphore value which is set to sem_val. For example, when a simulation begins the semaphore values 392 associated with each piece of terminal node state 390 are set to 0 and the sem_val 800 which is sent with the trigger commands (expected semaphore value 393) referred to in step 808 is set to 1. Therefore, the current semaphore value and the expected semaphore value are different for each piece of terminal node state 390.

At step 810 the SCUI 55 determines whether the sem_val has reached its maximum allowed value. If so, then processing proceeds to step 812. The SCUI 55 sends a gather packet 281 to all terminal nodes 54 when sim_val has reached its maximum allowed value. When this trigger command is received each the terminal node 54 completes processing of all prior trigger commands 383 and data commands 383 which it has received. The terminal nodes 54 also set the semaphore values 392 associated with each piece of terminal node state 390 to a value of 0. Each terminal node 54 then sends a gather packet 281 to the routing node 53 to which it is attached. The SCUI 55 then waits for all of the gather packets 281 to be collected by the routing nodes 55 and returned to the SCUI 55.

During the processing of a the trigger command 383 sent in step 808 the terminal nodes 54 may also send data commands 384 and trigger commands 383 to each other. For example, suppose an input to the circuit subset 276 of a first terminal node results in a change of value in of an input to the circuit subset 276 associated with a second terminal node 54. Then, the first terminal node 54 will send a data command 384 or trigger command 383 to the second terminal node 54 with the new signal value. When such a transfer is made a value equal to sem_val 800 is also sent in the data command 384 or trigger command 383. When the second terminal node 54 updates the signal value in response to the data command 384 or trigger command 383 it also updates the semaphore value 292 associated with the signal. Before using such signal values a terminal node 54 compares the semaphore value 392 with the expected semaphore value 393. If the two are not the same then use of the signal value is postponed until the values match.

In step 814 the SCUI 55 then determines whether the active input is a 2OUT signal. If so, then the SCUI 55 must wait until the value of any output which may change is known. This may be done by the terminal nodes 54 as they perform the processing which can change the value of the output signal. In this case the terminal nodes 54 send data commands 384 or trigger commands 383 destined for SCUI 55. A semaphore mechanism may be used within SCUI 55 to determine whether the command has arrived. An alternative embodiment is for SCUI 55 to send trigger commands 383 to those terminal nodes 54 which may have altered outputs to request the value of those outputs. The terminal nodes 54 then send data commands 384 or trigger commands 383 containing the requested data. Once the new values of the output signals are received by the SCUI 55 the SCUI 55 determines if any of the altered outputs affects the value of an input to the accelerator circuit subset 274. If so then processing proceeds to step 816. In step 816, that new input value is determined and added to the changed input list.

In step 818, after communicating with the accelerator 51 the SCUI 55 notifies the co-simulators 60 of the change to the value of the active input. The SCUI 55 then obtains any changes in the value of the outputs of the portion of the circuit mapped onto the co-simulators 60. Once again, if these outputs drive an input to the accelerator 51 then they are added to the input list. The other details of the co-simulation interface are determined by the particular co-simulator 60 used and are not discussed here.

In step 820, after processing of the active input is complete then the input list is examined. If it is empty then SCUI 55 returns to step 802. Otherwise, the next active input is processed by proceeding to step 808.

Method counterparts to each of these embodiments have been provided. Other system, methods, features and advantages of the invention will be or will become apparent to one with skill in the art upon examination of the following figures and detailed description. It is intended that all such additional system, methods, features and advantages be included within this description, be with the scope of the invention, and be protected by the accompanying claims.

What is claimed is:

1. In a logic simulator for simulating a logic circuit, said logic circuit containing a plurality of simulated logic devices, said logic simulator including:
a plurality of terminal node means for performing simulation processing,
a plurality of routing node means for routing simulation data between said terminal nodes,
a plurality of communications link means for transferring said simulation data between said routing nodes,
a plurality of sempahore means for storing semaphore values associated with said simulated logic devices,
a plurality of expected semaphore means for storing expected semaphore values associated with said simulated logic devices,
a plurality of comparison means for comparing said semaphore values with said expected semaphore values,
a processing ordering means for suspending the processing of simulation data by said terminal nodes if said semaphore values do not match said expected semaphore values.

2. In a logic simulator as in claim 1 including:
a system control and user interface means for controlling the progress of the simulation including:
a plurality of control node means for communicating with said terminal node means to controlling the progress of a simulation,
a control node network means for communications between said said control node means,
a sem_val means which is used to coordinate activities between said terminal node means during a simulation,
a gather packet means for coordinating between said system control and user interface means and said terminal node means during a simulation.
